(19) United States
(12) Patent Application Publication
(10) Pub. No.: US 2026/0300397 A1
(43) Pub. Date: Oct. 1, 2026

(54) GRAPH-BASED MODELS WITH PROBE NODES

(71) Applicant: Infosys Limited, Bangalore (IN)

(72) Inventor: Steven SCHILDERS, Columbus, IN (US)

(73) Assignees: Infosys Limited, Bangalore (IN); InvertIT Inc., Columbus, IN (US)

(21) Appl. No.: 19/089,638

(22) Filed: Mar. 25, 2025

(51) Int. Cl. G06F 16/901

(52) U.S. Cl. CPC G06F 16/9024

(57) ABSTRACT

An overlay system is provided that includes a storage element and processing circuitry coupled thereto. The storage element stores an executable graph-based model that includes a plurality of active nodes and a plurality of probe nodes. The processing circuitry receives a stimulus and identifies a first active node and a second active node based on the stimulus. The processing circuitry determines a first probe node associated with the first active node and/or the second active node. The processing circuitry executes a path detection operation based on the first probe node, the first active node, and the second active node. The processing circuitry determines, as a response to the stimulus, a third active node as an intersection node based on the path detection operation, with the intersection node being associated with each of the first active node and the second active node.

### FIELD OF THE DISCLOSURE

Various embodiments of the present disclosure relate generally to graph-based models. More specifically, various embodiments of the present disclosure relate to path detection in graph-based models.

### BACKGROUND

Graph-based models are extensively used in various domains, including but not limited to marketing, hospitality, and research, due to their ability to represent complex relationships between entities efficiently. These models consist of nodes including vertices and edges, where vertices represent real-world entities, and edges establish relationships between these entities. The inherent flexibility and adaptability of graph-based models make them highly effective for analyzing interconnected data and supporting a wide range of applications across various domains.

Despite their advantages, a significant challenge in graph-based models is the identification and utilization of indirect relationships between entities. While direct relationships are explicitly defined by edges, indirect relationships may emerge through multiple intermediary nodes, making them less evident. The complexity of identifying such relationships increases with the vast number of nodes present in modern graph-based applications. Presently, detection of such indirect relationships requires extensive computational resources and may not yield optimal results in real-time applications. In addition, due to the scale and complexity of modern graph-based models, efficiently detecting and processing such indirect relationships remains a challenge.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for implementing probe nodes to facilitate detection of paths in executable graph-based models are provided substantially as shown in, and described in connection with, at least one of the figures.

The methods and systems described herein provide an overlay system. The overlay system includes processing circuitry and a storage element coupled to the processing circuitry. The storage element is configured to store an executable graph-based model that includes a plurality of active nodes and a plurality of probe nodes. The processing circuitry is configured to receive a stimulus associated with the overlay system. The processing circuitry is further configured to identify, from the plurality of active nodes, at least a first active node and a second active node based on the stimulus. The processing circuitry is further configured to determine a first probe node of the plurality of probe nodes associated with at least one of the first active node or the second active node. The processing circuitry is further configured to execute a path detection operation based on the first probe node, the first active node, and the second active node. The processing circuitry is further configured to determine, as a response to the stimulus, a third active node, from the plurality of active nodes, as an intersection node based on the path detection operation, with the intersection node being associated with each of the first active node and the second active node.

In some embodiments, the first active node and the second active node are associated with each other by way of an indirect connection. The first active node is associated with the second active node via at least the third active node.

In some embodiments, each of the first active node and the second active node is one of a vertex node, an edge node, an overlay node, or a role node.

In some embodiments, a node-type of the first probe node corresponds to a combination of an edge node-type and an overlay node-type. The association of the first probe node with at least one of the first active node or the second active node is based on the edge node-type. The execution of the path detection operation by way of the first probe node is based on the overlay node-type.

In some embodiments, the first probe node has a first probing technique and a second probing technique associated therewith. The path detection operation is executed further based on implementation of the first probing technique and the second probing technique. Based on the execution of the path detection operation by way of the implementation of the first probing technique, the intersection node corresponds to the third active node. Based on the execution of the path detection operation by way of the implementation of the second probing technique, the intersection node corresponds to a fourth active node of the plurality of active nodes. The processing circuitry is further configured to compare, based on the first probe node, the third active node and the fourth active node for a set of parameters. The processing circuitry is further configured to determine, based on the comparison, the third active node as an optimal intersection node as the response to the stimulus.

In some embodiments, the set of parameters includes at least one of: (i) a cost of traversal between the first active node and the second active node, (ii) time required for a traversal between the first active node and the second active node, or (iii) processing requirement for the traversal between the first active node and the second active node.

In some embodiments, the third active node corresponds to an edge node of the executable graph-based model that couples the first active node and the second active node.

In some embodiments, the path detection operation corresponds to a unidirectional path detection operation. The third active node is determined further based on detection of a path from the first active node to the second active node.

In some embodiments, the path detection operation corresponds to a bi-directional path detection operation. The third active node is determined further based on detection of at least one of: (i) a first path from the first active node to the second active node or (ii) a second path from the second active node to the first active node. The third active node is associated with each of the first path and the second path.

In some embodiments, the third active node corresponds to one of an accessible node or an inaccessible node.

In some embodiments, based on the third active node being the inaccessible node, the processing circuitry is further configured to determine, based on the path detection operation, a fourth active node of the plurality of active nodes as the response to the stimulus. The fourth active node corresponds to an alternative intersection node that is associated with each of the first active node and the second active node.

In some embodiments, the first probe node corresponds to a first composite node of the executable graph-based model with a composite node being a combination of two or more probe nodes of the plurality of probe nodes. The first probe node includes a second probe node and a third probe node. The path detection operation is executed further based on the second probe node and the third probe node.

In some embodiments, the first probe node is associated with a first probing technique. Based on the first probe node being associated with the first probing technique, the processing circuitry is further configured to associate the first probing technique with each of the second probe node and the third probe node. The path detection operation is executed further based on each of the second probe node and the third probe node implementing the first probing technique.

In some embodiments, the first probe node is associated with a first probing technique. The second probe node is associated with a second probing technique. The processing circuitry is further configured to associate the third probe node with the first probing technique. The path detection operation is executed further based on the second probe node implementing the second probing technique and the third probe node implementing the first probing technique.

In some embodiments, the second probe node is associated with a first probing technique and the third probe node is associated with a second probing technique. The path detection operation is executed further based on the second probe node implementing the first probing technique and the third probe node implementing the second probing technique.

In some embodiments, at least one of the second probe node or the third probe node corresponds to the composite node.

In some embodiments, the first probe node is included in each of a first composite node and a second composite node, of the executable graph-based model. A composite node corresponds to a combination of two or more probe nodes of the plurality of probe nodes. The first composite node is associated with at least one of the first active node or the second active node. Based on the first composite node being associated with at least one of the first active node or the second active node, the path detection operation is executed further based on the first probe node implementing a first probing technique of the first composite node.

In some embodiments, the first probe node further includes a path dataset associated with the at least one of the first active node or the second active node. The path dataset is indicative of one or more active nodes of the plurality of active nodes that form one or more connection links between the first active node and the second active node. The path detection operation is executed further based on the path dataset of the first probe node.

In some embodiments, the executable graph-based model further includes a plurality of overlay nodes. The first probe node is associated with a first overlay node of the plurality of overlay nodes. The path detection operation is executed further based on the first overlay node.

In some embodiments, the first probe node corresponds to one of: a public access node, a private access node, or a protected access node.

In some embodiments, the first probe node corresponds to at least one of a manual probe node or an automated probe node.

In some embodiments, based on the stimulus being an external stimulus, the first probe node corresponds to the manual probe node.

In some embodiments, based on the stimulus being an internal stimulus, the first probe node corresponds to the automated probe node.

In some embodiments, for the execution of the path detection operation, the processing circuitry is further configured to use the first probe node to associate a first anchor point with the first active node and a second anchor point with the second active node. The path detection operation is executed further based on the first anchor point and the second anchor point.

In some embodiments, the first probe node corresponds to a stateful node. Based on the first probe node being the stateful node the determination of the third active node as the intersection node persists in the executable graph-based model upon an unloading of the first probe node.

In some embodiments, the first probe node corresponds to a stateless node. Based on the first probe node being the stateless node the determination of the third active node as the intersection node ceases to exist in the executable graph-based model upon an unloading of the first probe node.

In some embodiments, the processing circuitry is further configured to determine, based on the stimulus, whether at least one of: the first active node, the second active node, or the first probe node is unloaded from the executable graph-based model.

In some embodiments, based on at least one of the first active node, the second active node, or the first probe node being unloaded, from the executable graph-based model, the processing circuitry is further configured to load at least one of the first active node, the second active node, or the first probe node, in the executable graph-based model.

In some embodiments, each of the first active node and the second active node corresponds to a generic node, and the first probe node corresponds to a generic probe node.

In some embodiments, each of the first active node and the second active node corresponds to a run-time node that includes (i) a node template that defines a node structure and (ii) a node instance that is an implementation of the node template. Based on each of the first active node and the second active node being the run-time node, the first probe node corresponds to a runtime probe node that includes (i) a probe node template that defines a probe node structure and (ii) a probe node instance that is an implementation of the probe node template.

In some embodiments, the run-time node is loaded based on loading of the node template and the node instance. The run-time probe node is loaded based on loading of the probe node template and the probe node instance.

A method is provided. The method comprising receiving, by processing circuitry of an overlay system, a stimulus associated with the overlay system. The method further comprising an executable graph-based model stored in a storage element of the overlay system and including a plurality of active nodes and a plurality of probe nodes. The method further comprising identifying, by the processing circuitry, from the plurality of active nodes, at least a first active node and a second active node based on the stimulus. The method further comprising determining, by the processing circuitry, a first probe node of the plurality of probe nodes associated with at least one of the first active node or the second active node. The method further comprising executing, by the processing circuitry, a path detection operation based on the first probe node, the first active node, and the second active node. The method further comprising determining, by the processing circuitry based on the path detection operation, a third active node, from the plurality of active nodes, as a response to the stimulus. The third active node corresponds to an intersection node associated with each of the first active node and the second active node.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a run-time node within the executable graph-based model, consistent with disclosed embodiments of the present disclosure;

FIG. 4A is a block diagram that illustrates a standard structure of generic probe node within the executable graph-based model, consistent with disclosed embodiments of the present disclosure;

FIG. 4B is a block diagram that illustrates a standard structure of a run-time probe node within the executable graph-based model, consistent with disclosed embodiments of the present disclosure;

FIG. 5A is a block diagram that illustrates an executable generic probe node within the executable graph-based model, consistent with disclosed embodiments of the present disclosure;

FIG. 5B is a block diagram that illustrates an executable run-time probe node within the executable graph-based model, consistent with disclosed embodiments of the present disclosure;

FIG. 6 is a block diagram that illustrates a composition of the executable generic probe node that enables persistent storage of data and processing logic associated therewith, consistent with disclosed embodiments of the present disclosure;

FIGS. 7A and 7B illustrate graphs that, collectively, depict scenarios for implementation of a plurality of probe nodes in conjunction with a plurality of generic nodes of the executable graph-based model, consistent with disclosed embodiments of the present disclosure;

FIG. 8 illustrates a graph that depicts implementation of the plurality of probe nodes in conjunction with a plurality of run-time nodes of the executable graph-based model, consistent with disclosed embodiments of the present disclosure;

FIG. 9 illustrates a graph that depicts implementation of probe nodes for performing a path detection operation associated with three or more active nodes, consistent with disclosed embodiments of the present disclosure;

FIG. 10 illustrates a graph that depicts a recommendation system implemented using the executable graph-based model, consistent with disclosed embodiments of the present disclosure;

FIG. 11 shows an example computing system for carrying out methods of the present disclosure, consistent with disclosed embodiments of the present disclosure; and

FIG. 12 illustrates a flowchart of a method for implementation of probe nodes in the executable graph-based model, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Graph-based models are widely implemented across diverse industries due to their capability to effectively represent and analyze interconnected data. These models, consisting of nodes, including vertices and edges, facilitate the establishment of relationships between entities, making them valuable for applications that rely on complex relational structures. Their flexibility and scalability enable efficient data processing and support various use cases that require analyzing interconnections between multiple entities.

A key challenge in utilizing graph-based models is the identification of indirect relationships between entities. While direct relationships are explicitly represented through edges, indirect associations often arise through intermediary nodes, making them more difficult to detect. As graph structures continue to scale in complexity, uncovering these hidden relationships becomes increasingly challenging.

Extracting and leveraging indirect relationships is crucial for enhancing the performance of graph-based applications. For instance, identifying hidden associations between users and products can refine recommendation systems, while uncovering less obvious links between research datasets can drive new discoveries. In industries such as hospitality and finance, recognizing implicit relationships can lead to improved decision-making and operational efficiency.

Given the increasing size and complexity of modern graphs, conventional techniques for detecting and processing indirect relationships often require significant computational resources and may not be optimal for real-time applications. As a result, there is a growing demand for innovative methods that can efficiently identify and utilize these hidden connections to enhance the effectiveness of graph-based models across various domains.

The present disclosure is directed to facilitation of probe nodes in an executable graph-based model of an overlay system. The executable graph-based model is a customized hypergraph with hyper-edges that are realized by way of executable nodes. Each executable node is associated with a particular node-type. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features in the overlay system. Each overlay node is associated with one or more nodes (for example, a vertex node, an edge node, or the like) of the executable graph-based model and includes a corresponding processing logic that when executed implements a functionality thereof on the associated nodes. Hence, the processing logic is implemented within the executable graph-based model and is not required to be retrieved from any external system.

The overlay system disclosed herein facilitates the probe nodes in the executable graph-based model. The executable graph-based model may include a plurality of active nodes (for example, a plurality of generic nodes or a plurality of run-time nodes). Each active node may be associated with one or more other active nodes based on a direct association or an indirect association. Based on a first active node being associated with a second active node by way of the indirect association, the first node may be associated with the second active node by way of one or more intermediate active nodes. In some scenarios, based on the first active node being associated with the second active node by way of the intermediate active nodes, the association may be not evident. In such instances, a probe node associated with the first active node or the second active node may execute a path detection operation to determine a connection link between the first active node and the second active node. The connection link may include a set of intermediate active nodes. Based on the determined connection link, a third active node may be selected from the set of intermediate active nodes. The third active node may correspond to an intersection node that may be associated with the first active node as well as the second active node. The intersection node may act as a point of commonality between the first active node and the second active node. The intersection node may be used to refer to or access the first active node and the second active node directly or indirectly. This makes the non-evident association, between the first active node and the second active node, evident and usable. Hence, various operations associated with the first active node and/or the second active node may be optimized by leveraging the intersection node.

Thus, the overlay system disclosed herein allows for implementation of probe nodes in conjunction with active nodes. The disclosed overlay system effectively eliminates the challenges associated with traditional graph-based models by efficiently identifying and utilizing relationships between active nodes, even in large and complex datasets. Identification of such associations simplifies complex operations and significantly reduces computational demands of such operations while ensuring real-time processing capabilities. Application of probe nodes for detection of indirect and non-obvious connections, leads to improved insights for the overlay system as well as various applications such as recommendation systems, fraud detection, and network analysis, or the like, implemented by way of the overlay system. Additionally, the disclosed overlay system is highly scalable, making it suitable for handling vast and dynamic datasets across various industries, including marketing, hospitality, research, healthcare, and finance.

### FIGURE DESCRIPTION

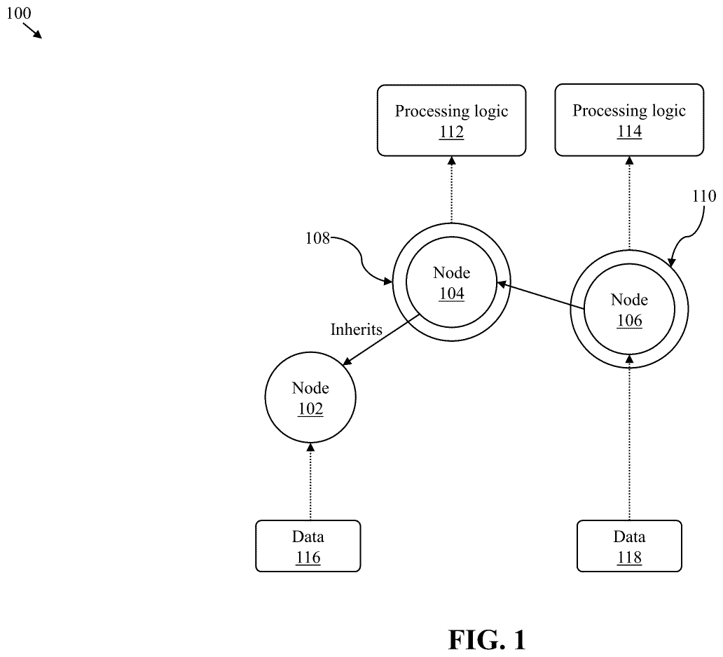

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of active nodes 102-106 which can be functionally extended with processing logic via the use of overlays. Each of the plurality of active nodes 102-106 may also be referred to as a node. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At runtime, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

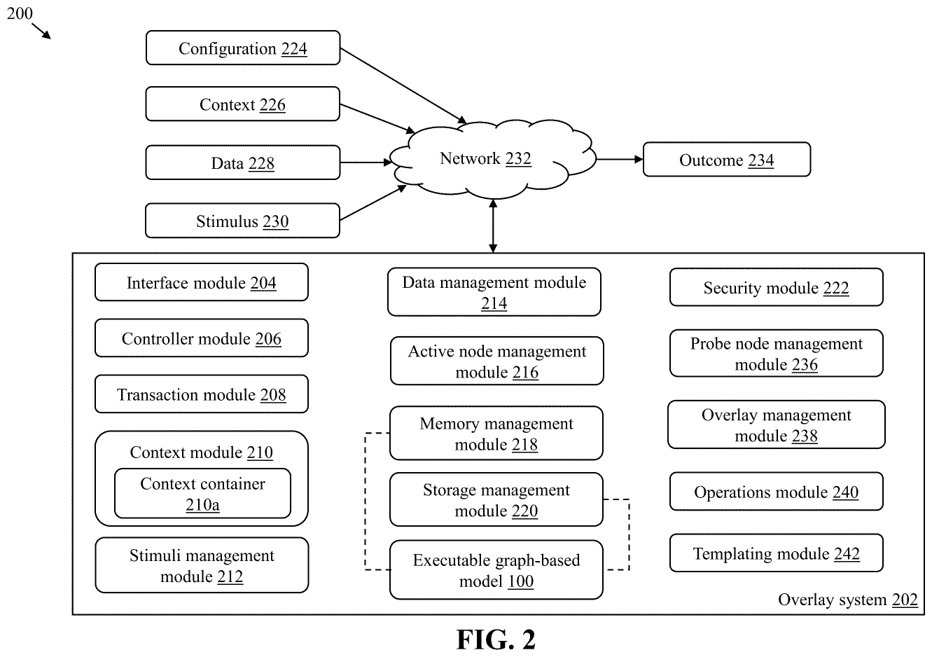

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, an active node management module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes a probe node management module 236, an overlay management module 238, an operations module 240, and a templating module 242. In some embodiments, all the modules of the overlay system 202 except for the executable graph-based model 100 may collectively form processing circuitry that facilitates operations associated with a plurality of active nodes and a plurality of probe nodes of the executable graph-based model 100. The plurality of active nodes may include generic nodes and run-time nodes.

A generic node may refer to a node, in the executable graph-based model 100, with an edge node-type, a role node-type, an overlay node-type, or a vertex node-type. A first generic node with the vertex node-type is coupled to a second generic node with the vertex node-type by way of a third generic node with the edge node-type indicative of roles of the first and second generic nodes. A run-time node may include a node template and node instance. The node template may be a predefined node structure and the node instance may be an implementation of the predefined node structure. The run-time node may have an edge node-type, a role node-type, an overlay node-type, or a vertex node-type. A first run-time node with the vertex node-type is coupled to a second run-time node with the vertex node-type by way of a third run-time node with the edge node-type indicative of roles of the first and second run-time nodes. A generic node and a run-time node are, collectively, referred to as an active node.

An active node of the plurality of active nodes of the executable graph-based model 100 may be associated with one or more active nodes of the plurality of active nodes. Such an association may be based on a direct connection or an indirect connection. The direct connection refers to association of the active node with the one or more active nodes directly and without any other active nodes acting as intermediary nodes. The indirect connection refers to association of the active node with the one or more active nodes of the plurality of active nodes through one or more active nodes acting as intermediary active nodes. In some instances, such indirect connections may be non-evident. Hence, the association between the active node and the one or more active nodes may not be obvious. Also, such an association may be utilized to optimize operations associated with the active node and the one or more active nodes. In an example, a first active node may represent a first person, the first active node may be associated with a set of active nodes that may represent grocery items purchased by the first person. A second active node of the set of active nodes may be further associated with a third active node representing a second person. In such an example, the grocery items represented by the set of active nodes may be useful to the second person. Hence, the grocery items represented by the set of active nodes may be suggested to the second person. Therefore, it may be of significant importance to determine a path created by indirect connections that associate two or more active nodes. The path may be used to determine an intersection node that may be associated with each active node of the two or more active nodes. The intersection node may be used to generate queries to determine information associated with each of the two or more active nodes.

The overlay system 202 may include suitable logic, circuitry, interfaces, and/or code, executable by the circuitry, that may be configured to facilitate one or more operations associated with the active nodes and the probe nodes in the executable graph-based model 100.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202.

The controller module 206 may maintain the integrity of the modules within the overlay system 202 before, during, and after a system transaction. The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. Each defined context of the set of defined contexts pertains to a context that is associated with one or more operations for facilitating application and management of the plurality of nodes (for example, the active nodes) in the overlay system 202. That is to say that, one or more contexts of the set of defined contexts are indicative of the one or more operations to be executed by way of one or more active nodes in the overlay system 202. The one or more operations are executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IOT) device. As previously stated, a stimulus (such as the stimulus 230) can be either externally or internally generated. In an embodiment, the stimulus 230 may be an internal stimulus. The stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another embodiment, the stimulus 230 may be an external stimulus. The stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 240 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the storage management module 220.

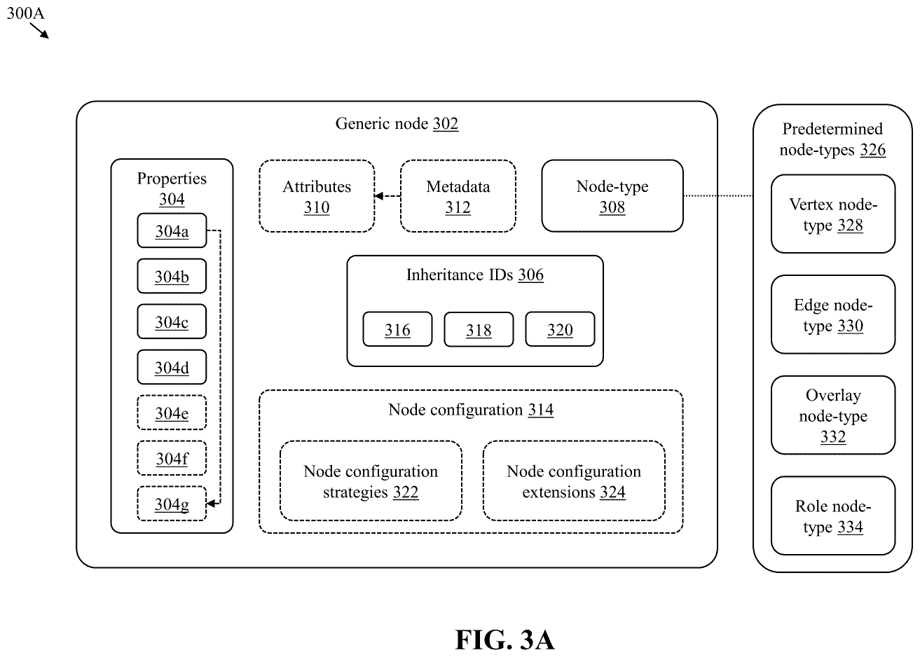

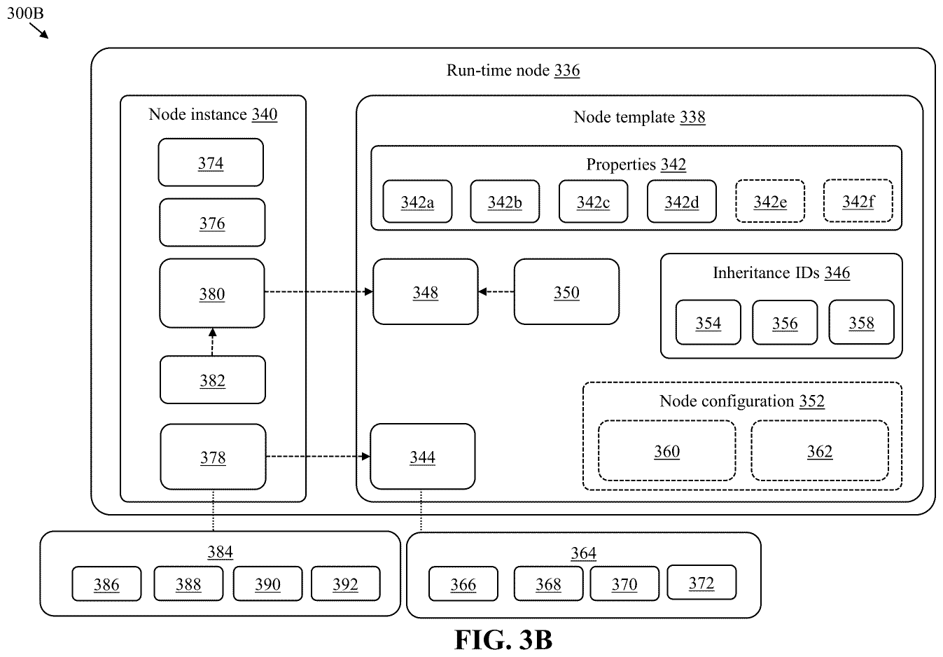

The active node management module 216 may include suitable logic, circuitry, interfaces, and/or code, executable by the circuitry, configured to manage, design, and implement the plurality of active nodes in the overlay system 202. The active nodes may include the generic nodes and the run-time nodes. Further, each active node may have a vertex node-type, an edge node-type, a role node-type, or an overlay node-type (described in conjunction with FIGS. 3A and 3B). Further, each active node may have a functionality associated therewith. The active node management module 216 is further configured to facilitate operations associated with execution of one or more transactions using the active nodes.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

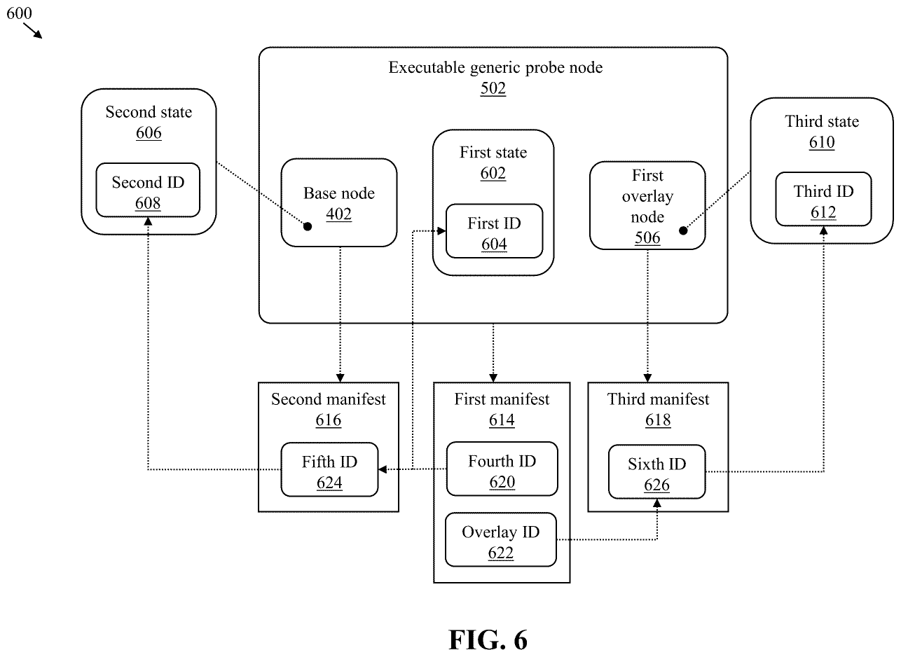

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage of manifest states (including manifest template states and manifest instance states) of active nodes. The storage element may include a primary storage and a secondary storage. The primary storage may store the executable graph-based model 100 and may also store nodes that are loaded in the executable graph-based model 100. The secondary storage may store node states, manifests, and manifest states associated with nodes that are unloaded from the executable graph-based model 100. Storage and retrieval of active nodes are described in detail in conjunction with FIG. 6.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 238 for managing and executing security-based overlays and security-based operational functionalities associated with one or more active nodes and one or more probe nodes of the executable graph-based model 100.

A probe node, when instantiated in association with at least a first active node (for example, the generic node and the run-time node) of the plurality of active nodes of the executable graph-based model 100, may determine an intersection node associated with the first active node and at least a second active node associated therewith. An intersection node may correspond to an intermediate active node (namely, intermediary active node) that is associated with each of the first active node and at least the second active node. The intersection node may be used as a point of commonality among the first active node and at least the second active node. The point of commonality may refer to an active node with the edge node-type that may be used to execute an operation based on the first active node and at least the second active node.

The probe node management module 236 may include suitable logic, circuitry, interfaces, and/or code, executable by the circuitry, configured to execute one or more operations associated with implementation of a plurality of probe nodes in the executable graph-based model 100. The probe node management module 236 may be further configured to enable each of the plurality of probe nodes to be associated with one or more active nodes of the plurality of active nodes of the executable graph-based model 100. The probe node management module 236 is further configured to enable each of the plurality of probe nodes to execute path detection operations to identify intersection nodes associated with one or more active nodes coupled thereto.

The overlay management module 238 may include suitable logic, circuitry, interfaces, and/or code, executable by the circuitry, configured to manage all overlays within the overlay system 202. The overlays may be generic overlays or run-time overlays. Generic overlays are associated with generic nodes and extend functionality of the generic nodes. A run-time overlay node is same as the generic overlay node. In addition, the run-time overlay node may include a node template and a node instance. Operations performed by the overlay management module 238 may include overlay storage management, overlay structure modeling, overlay logic creation and execution, and overlay loading and unloading (within the executable graph-based model 100). The overlay management module 238 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution. A generic overlay node and a run-time overlay node are, collectively, referred to as an overlay node.

The operations module 240 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like).

The templating module 242 may include suitable logic, circuitry, interfaces, and/or code, executable by the circuitry, configured to enable the overlay system 202 to implement a templated version of one or more nodes (for example, the run-time nodes, the run-time probe nodes, or the like) of the executable graph-based model 100. The templating module 242 may be configured to create one or more predefined templates in the executable graph-based model 100. The templating module 242 may be further configured to generate one or more node instances of the predefined node templates for the implementation of the templated version of the executable graph-based model 100. Notably, the templating module 242 ensures ontology integrity by enforcing structure and rules of a template when generating instances of the template at run-time. Ontology integrity refers to consistency, accuracy, and correctness of an ontology. Thus, the templating module 242 ensures that the consistency, accuracy, and correctness of the ontology of the executable graph-based model 100 are maintained while generating the instances of the template at run-time. The templating module 242 may be communicatively coupled (i.e., connected either directly or indirectly) to one or more nodes and/or one or more overlays within the executable graph-based model 100.

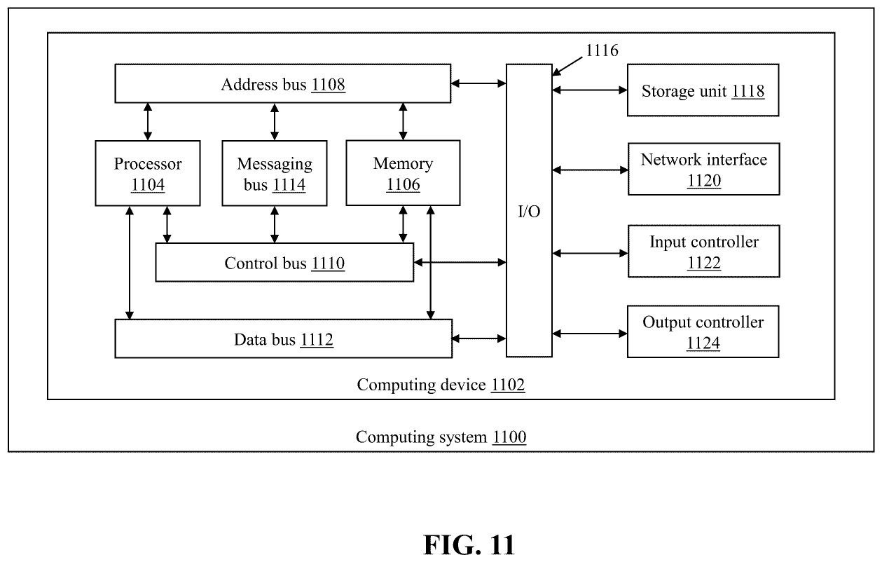

Beneficially, various features of the overlay system 202 support the processing circuitry and a computing system (shown in FIG. 11) implementing the overlay system 202 in significantly enhancing its performance. The significant enhancement in performance may include significantly increased throughput and efficiency, as well as significantly reduced cost complexity, processing complexity, time complexity, latency, waiting time, turnaround time, or the like.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model, specifically, the concept of a node. Unlike conventional graph-based systems, all elements (e.g., data, overlays, etc.) within the executable graph-based model 100 are implemented as nodes. As will become clear, this allows executable graph-based models to be flexible, extensible, and highly configurable.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to a generic node of the executable graph-based model 100. The generic node 302 further corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an executing system at run-time (e.g., in the context of execution of an executable graph-based model).

FIG. 3A further shows the plurality of predetermined node-types 326 which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332 and a role node-type 334. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, or a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of concrete node configuration strategies 322 is versioning strategies, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake®, or the like) associated with the overlay system 202. All attribute configurations examples of node configuration extensions 324.

FIG. 3B is a block diagram 300B that illustrates a standard structure of a run-time node 336 within the executable graph-based model 100, consistent with disclosed embodiments of the present disclosure. Referring to FIG. 3B, the run-time node 336 corresponds to the core structure of the executable graph-based model 100 and forms the foundational building block for all data and processing logic within the executable graph-based model 100. The run-time node 336 is shown to include a node template 338 and a node instance 340. The node instance 340 is generated according to the node template 338. The node template 338 forms a data structure for the node instance 340. In other words, the node instance 340 is an implementation of the node template 338. The run-time node 336 shown in FIG. 3B is a compositional structure that is generated and executed, at run-time as part of the executable graph-based model 100. In other words, the node template 338 is defined as ‘offline’ and the node instance 340 and the run-time node 336 are run-time structures that are dynamically generated during execution of the executable graph-based model 100.

The node template 338 comprises a predetermined node structure. Further, the node template 338 defines one or more rules that govern the generation of the node instance 340. The node instance 340 is an implementation of the predefined node structure of the node template 338. In other words, the node instance 340 is generated based on the predetermined node structure and the one or more rules of the node template 338. The node template 338 cannot be modified during the execution but may be modified during offline mode or at rest. During execution, only the node instance 340 of the run-time node 336 may be modified.

The node template 338 includes properties 342, a node-type template 344, inheritance IDs 346, and a set of attribute templates 348. The node template 338 may optionally include metadata 350 and a node configuration 352. The properties 342 of the node template 338 include a unique identifier (ID) 342a, a version ID 342b, a namespace 342c, a name 342d, and optionally include one or more icons 342e and a set of labels 342f. The inheritance IDs 346 comprise an abstract flag 354, a leaf flag 356, and a root flag 358. The node configuration 352 optionally comprises one or more node configuration strategies 360 and/or one or more node configuration extensions 362. The node configuration strategies 360 and/or the node configuration extensions 362 may have descriptions similar to the node configuration strategies 322 and/or the node configuration extensions 324.

FIG. 3B further shows a plurality of predetermined node-type templates 364 of the node-type template 344. The plurality of predetermined node-type templates 364 includes a vertex node-type template 366, an edge node-type template 368, an overlay node-type template 370, and a role node-type template 372. Further, the node instance 340 includes a unique ID 374, a version ID 376, a node-type instance 378, and a set of attribute instances 380. The node instance 340 may optionally include metadata 382. FIG. 3B further shows a plurality of predetermined node-type instances 384 of the node-type instance 378. The plurality of predetermined node-type instances 384 include a vertex node-type instance 386, an edge node-type instance 388, an overlay node-type instance 390, and a role node-type instance 392.

The unique ID 342a is unique for each node template within the executable graph-based model 100. Similarly, the unique ID 374 is unique for each node instance within the executable graph-based model 100. The unique ID 342a and the unique ID 374 are used to register, manage, and reference the node template 338 and the node instance 340, respectively, within the overlay system 202. The version ID 342b of the node template 338 is incremented when the node template 338 undergoes transactional change. Similarly, the version ID 376 of the node instance 340 is incremented when the node instance 340 undergoes transactional change. The namespace 342c of the node template 338, along with the name 342d of the node template 338, is used to help organize node templates within the executable graph-based model 100. That is, the node template 338 is assigned a unique name 342d within the namespace 342c such that the name 342d of the node template 338 need not be unique within the entire executable graph-based model 100, only within the context of the namespace 342c to which the node template 338 is assigned. The node template 338 optionally comprises one or more icons 342e which are used to provide a visual representation of the node template 338. The one or more icons 342e can include icons at different resolutions and display contexts such that the visualization of the node is adapted to different display contexts and settings. The node template 338 also optionally comprises the set of labels 342f which are used to override the name 342d when the node template 338 is rendered or visualized.

The node template 338 supports the software development feature of multiple inheritance by maintaining references (not shown) to zero or more other node templates, which then act as the base of the node template 338. This allows the behavior and functionality of a node template to be extended or derived from one or more other node templates within an executable graph-based model (such as the executable graph-based model 100). The node instance 340 likewise supports multiple inheritance because it is an instance representation of the node template 338. The multiple inheritance structure of the node instance 340 is, however, limited to the corresponding instance realization of the multiple inheritance structure defined by the node template 338, i.e., one node instance 340 is created and managed for each node template 338 defined in the inheritance hierarchy for a node instance of a node template.

The inheritance IDs 346 of the node template 338 provide an indication of the inheritance-based information, which is applicable, or can be applicable, to the node template 338. The inheritance IDs 346 have a description that is similar to the inheritance IDs 306. The abstract flag 354 has a description that is similar to the abstract flag 316, the leaf flag 356 has a description that is similar to the leaf flag 318, and the root flag 358 has a description that is similar to the root flag 320.

In embodiments, when an active node may be a run-time node, all elements (for example, probe nodes) within the executable graph-based model 100 are defined as node templates or node instances. The functionality of the node template 338 and the node instance 340 are realized due to the use of the node-type template 344 and the node-type instance 378. The node-type template 344 of the node template 338 is used to extend the functionality of the node template 338 by defining the standard set of capabilities, including data and associated behavior.

The vertex node-type template 366 (also referred to as a data node-type) includes a template of common data structures and functionality related to the ‘things’ modeled in the graph (e.g., the data). The vertex node-type instance 386 includes the common data structures and functionality related to the ‘things’ modeled in the graph based on the vertex node-type template 366. The edge node-type template 368 includes a template of common data structures and functionality related to joining two or more nodes. A node instance having the edge node-type instance 388 may connect two or more nodes and thus the edge node-type instance 388 constructs associations and connections between nodes (for example objects or ‘things’) within the executable graph-based model 100. The edge node-type instance 388 is not restricted to the number of nodes that can be associated or connected by a node having the edge node-type instance 388. The data structures and functionality of the edge node-type instance 388 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The role node-type template 372 is used to define structure, conditions, or the like for establishing a connective relationship between two node instances or node templates. Similarly, the role node-type instance 392 is used to define a connective relationship between two node instances. The overlay node-type template 370 is used to extend the functionality of a node template (e.g., the node template 338) to incorporate processing logic. Similarly, the overlay node-type instance 390 is used to extend the functionality of a node instance (e.g., the node instance 340) to incorporate processing logic.

The set of attribute templates 348 corresponds to the data defined by the node template 338. For example, the set of attribute templates 348 may define the names and value types (e.g., integer, string, float, etc.) of one or more attributes but not the values of these attributes. The values of the set of attribute templates 348 may be defined by the set of attribute instances 380 of the node instance 340 through one or more values or instance values. For example, the node template 338 may define a string attribute ‘surname’ and the corresponding node instance 340 may assign the instance value ‘Bell-Richards’ to this string attribute. Each attribute instance of the set of attribute instances 380 is associated with an attribute template of the set of attribute templates 348. The node template 338 may define one or more default values for the set of attribute templates 348. The default values correspond to the values that the attributes take if no value is assigned. The metadata 350 (e.g., data stored as a name, a value type, and a value triplet) is associated with either the node template 338 or one or more of the set of attribute templates 348 of the node template 338. Similarly, the node instance 340 also optionally comprises the metadata 350 (e.g., data stored as a name, a value type, and a value triplet) which is associated with either the node instance 340 or one or more of the set of attribute instances 380.

The node configuration 352 provides a high degree of configurability for the different elements of a node template and/or a node instance. An example of a concrete node configuration strategy is an ID strategy, associated with the configuration of the unique ID 342a of the node template 338. A further example of a concrete node configuration strategy is a versioning strategy, associated with the configuration of the version ID 342b of the node template 338 which supports major and minor versioning (depending on the type of transactional change incurred). The versioning strategy may be adapted to a native filing system of a user device hosting the overlay system 202 or a third-party data storage (for example, Snowflake®, or the like) associated with the overlay system 202.

It will be apparent to a person skilled in the art that each node of the executable graph-based model 100 has a generic structure that is similar to the node 302 of FIG. 3A or the run-time node 336 of FIG. 3B.

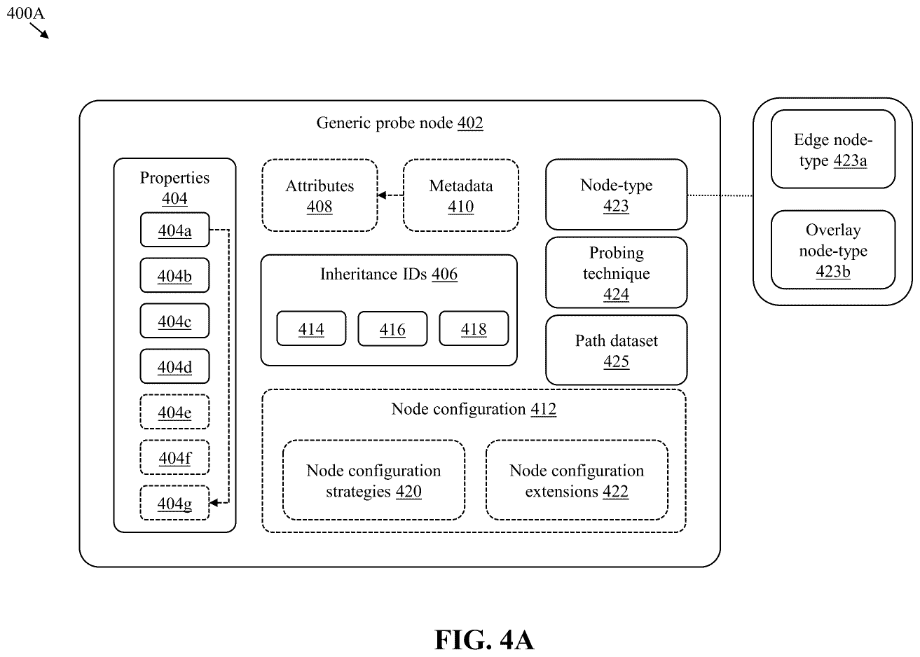

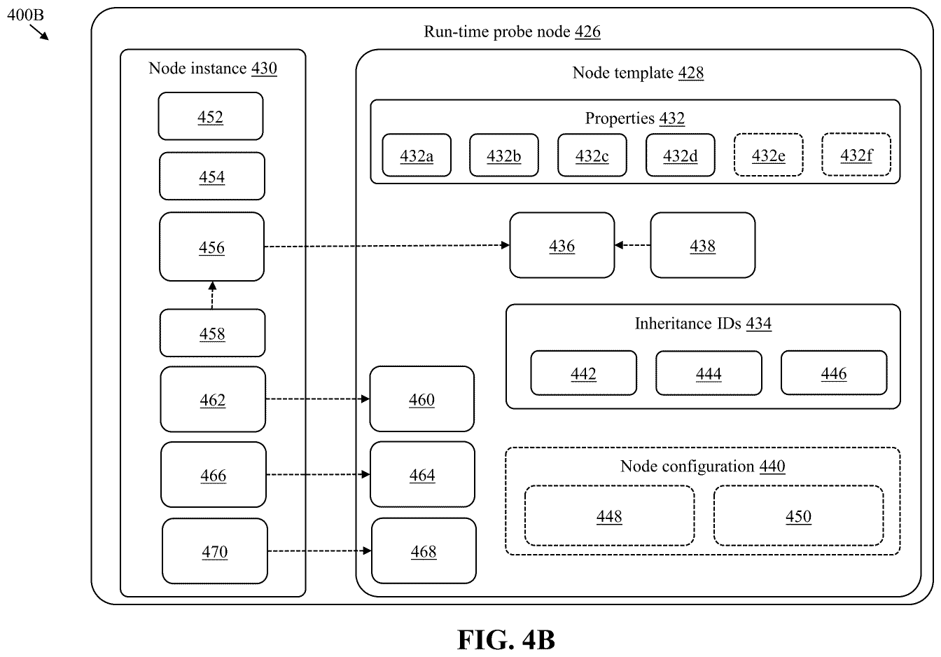

A standard node structure of the generic node and the run-time node (as described later in conjunction with FIGS. 3A and 3B, respectively) may be modified to form a generic probe node (depicted in FIG. 4A) and a run-time probe node (depicted in FIG. 4B), respectively, in the executable graph-based model 100. The generic probe node and the run-time probe node are collectively referred to as a probe node.

FIG. 4A is a block diagram 400A that illustrates a standard structure of a generic probe node 402 within the executable graph-based model 100, consistent with disclosed embodiments of the present disclosure. Referring to FIG. 4A, the generic probe node 402 corresponds to the core structure of the executable graph-based model 100 and forms the foundational building block for various data and processing logic within the executable graph-based model 100. The standard structure of the generic probe node 402 is derived from the standard structure of the generic node 302. The generic probe node 402 includes properties 404, inheritance IDs 406, attributes 408, metadata 410, and a node configuration 412.

The properties 404 include a unique ID 404a, a version ID 404b, a namespace 404c, a name 404d, one or more icons 404e, one or more labels 404f, and one or more alternative IDs 404g. The properties 404 of the generic probe node 402 may have a description similar to the description of the properties 304 of the generic node 302. In other words, the unique ID 404a, the version ID 404b, the namespace 404c, the name 404d, the one or more icons 404e, the one or more labels 404f, and the one or more alternative IDs 404g may have a description similar to the description of the unique ID 304a, the version ID 304b, the namespace 304c, the name 304d, the one or more icons 304e, the one or more labels 304f, and the one or more alternative IDs 304g, respectively, of the generic node 302.

The inheritance IDs 406 of the generic probe node 402 include an abstract flag 414, a leaf flag 416, and a root flag 418. The inheritance IDs 406 of the generic probe node 402 may have a description similar to the description of the inheritance IDs 306 of the generic node 302. In other words, the abstract flag 414, the leaf flag 416, and the root flag 418 may have a description similar to the description of the abstract flag 316, the leaf flag 318, and the root flag 320, respectively, of the generic node 302.

The attributes 408 may have a description similar to the description of the attribute 310. Additionally, the metadata 410 may have a description similar to the description of the metadata 312.

The node configuration 412 of the generic probe node 402 includes node configuration strategies 420 and node configuration extensions 422. The node configuration 412 is same as the node configuration 314 of the generic node 302. In other words, the node configuration strategies 420 and the node configuration extensions 422 of the generic probe node 402 may have a description similar to the description of the node configuration strategies 322 and the node configuration extensions 324, respectively, of the generic node 302.

The generic probe node 402 further has a node-type 423. The node-type 423 may be a combination of an edge node-type 423a and an overlay node-type 423b. The edge node-type 423a may have a description similar to the description of the edge node-type 330. The overlay node-type 423b may have a description similar to the description of the overlay node-type 332. The generic probe node 402 based on the edge node-type 423a may further include features of a role node-type that may have a description similar to the description of the role node-type 334. The generic probe node 402 may be associated with an active node (for example, the generic node 302) based on the edge node-type 423a. The generic probe node 402 may be further configured to execute a path detection operation based on the associated active node and a corresponding probing technique based on the overlay node-type 423b.

The generic probe node 402 may further include one or more probing techniques 424 indicative of one or more path detection algorithms that may be executed by the generic probe node 402 on two or more active nodes to detect a path therebetween and subsequently find an intersection node associated with each of the two or more active nodes. A probing technique of the probing techniques 424 may correspond to a path detection algorithm known in the art that may be customized/modified to adhere to the structure and constraints of the overlay system 202 while being utilized for execution of a path detection operation. Examples of the path detection algorithm that may be customized/modified may include, but are not limited to, Dijkstra's algorithm, A* algorithm, cycle detection algorithms, breadth-first search algorithm, depth-first search algorithm, maximum flow algorithm, minimum spanning tree algorithm, and Kosaraju's algorithm.

In addition, the generic probe node 402 may include a path dataset 425 that may correspond to path information pertaining to at least one active node (for example, the generic node 302) associated with the generic probe node 402. The path dataset may include a count of paths associated with the at least one active node and a unique IDs of each active node that may act as an intermediate active node and may form a path (namely, a connection link) associated with the active node. Notably, an active node with an edge node-type (for example, the edge node-type 330) may associate two or more active nodes. Therefore, the intermediate active node may be an active node with an edge node-type (for example, the edge node-type 330). Notably, based on an active node associated with a probe node being a generic node, the probe node is a generic probe node.

FIG. 4B is a block diagram 400B that illustrates a standard structure of a run-time probe node 426 within the executable graph-based model 100, consistent with disclosed embodiments of the present disclosure. Referring to FIG. 4B, the run-time probe node 426 corresponds to the core structure of the executable graph-based model 100 and forms the foundational building block for all data and processing logic within the executable graph-based model 100. The standard structure of the run-time probe node 426 may be derived from the standard structure of the run-time node 336. The run-time probe node 426 is shown to include a node template 428 and a node instance 430. The node template 428 of the run-time probe node 426 may correspond to a probe node template whereas the node instance 430 of the run-time probe node 426 may correspond to a probe node instance. The node instance 430 is generated according to the node template 428. The node template 428 forms a data structure for the node instance 430. Notably, the node template 428 corresponds to a predefined probe node structure. The node template 428 includes a reference (for example, a pointer, an identifier, or the like) to a node template of each run-time node associated with the run-time probe node 426. Similarly, the node instance 430 may include a reference (for example, a pointer, an identifier, or the like) to a node instance of each runtime node associated with the run-time probe node 426. The run-time probe node 426 shown in FIG. 4B is a compositional structure that is generated and executed, at run-time as part of the executable graph-based model 100. In other words, the node template 428 is defined as ‘offline’ and the node instance 430 and the run-time probe node 426 may be run-time structures that may be dynamically generated during execution of the executable graph-based model 100.

The node template 428 may have a description similar to the node template 338 described in conjunction with FIG. 3B. Similarly, the node instance 430 may have a description similar to the node instance 340 described in conjunction with FIG. 3B.

The node template 428 may include properties 432, inheritance IDs 434, and a set of attribute templates 436. The node template 428 may optionally include metadata 438 and node configuration 440. The properties 432 of the node template 428 include a unique identifier (ID) 432a, a version ID 432b, a namespace 432c, a name 432d, and optionally include one or more icons 432e and a set of labels 432f. The inheritance IDs 434 comprise an abstract flag 442, a leaf flag 444, and a root flag 446. The node configuration 440 optionally comprises one or more node configuration strategies 448 and/or one or more node configuration extensions 450. Further, the node instance 430 may include a unique ID 452, a version ID 454, and a set of attribute instances 456. The node instance 430 may optionally include metadata 458.

The properties 432 of the node template 428 may have a description that is similar to the description of the properties 342 described in conjunction with FIG. 3B. In other words, the unique ID 432a, the version ID 432b, the namespace 432c, the name 432d, the icons 432e, and the set of labels 432f have descriptions that may be similar to descriptions of the unique ID 342a, the version ID 342b, the namespace 342c, the name 342d, the icons 342e, and the set of labels 342f, respectively, shown in FIG. 3B.

The inheritance IDs 434 of the node template 428 may have a description that is similar to the inheritance IDs 346 of the node template 338. In other words, the abstract flag 442, the leaf flag 444, and the root flag 446 may have descriptions that may be similar to the abstract flag 354, the leaf flag 356, and the root flag 358, respectively, shown in FIG. 3B.

The set of attribute templates 436 has a description that is similar to the description of the set of attribute templates 348 described in conjunction with FIG. 3B. The metadata 438 has a description that is similar to the metadata 350 depicted in FIG. 3B. Similarly, the set of attribute instances 456 has a description that is similar to the set of attribute instances 380 of FIG. 3B and the metadata 458 have a description that is similar to the metadata 382 of FIG. 3B.

The node configuration 440 has a description that may be similar to the node configuration 352 of FIG. 3B. In other words, descriptions of the node configuration strategies 448 and the node configuration extensions 450 may be similar to the descriptions of the node configuration strategies 360 and the node configuration extensions 362, respectively, of FIG. 3B.

The node template 428 and the node instance 430 may have a node-type template 460 and a node-type instance 462. The node-type template 460 may be a combination of an edge node-type template and an overlay node-type template. The edge node-type template may have a description similar to the edge node-type template 368 and the overlay node-type template may have a description similar to the overlay node-type template 370. The node-type instance 462 may be a combination of an edge node-type instance and an overlay node-type instance. The edge node-type instance may have a description similar to the edge node-type instance 388 and the overlay node-type instance may have a description similar to the description of the overlay node-type instance 390. Therefore, the run-time probe node 426 may have the node-type that may be a combination of the edge node-type and the overlay node-type.

Moreover, the run-time probe node 426 may implement one or more probing techniques for performing one or more path detection operations. To enable such an implementation, as shown, the node template 428 may further include a probing technique template 464 that may define a template for defining, generating, or implementing one or more probing techniques for performing path detection operation on at least one active node (for example, the run-time node 336) associated with the run-time probe node 426. The node instance 430 may further include a probing technique instance 466 that may include one or more instructions implemented by way of the probing technique template 464 that may be executed for performing the path detection operation.

The run-time probe node 426 may further include a path dataset that is indicative of a count of paths (namely, connection links) associated with a run-time active node coupled to the run-time probe node 426. Each path may be made of one or more intermediate active nodes. The path dataset may further include unique IDs associated with the intermediate nodes. The node template 428 may further include a path dataset template 468 that may define a template for storing the path dataset. The node instance 430 may further include a path dataset instance 470 that may include values for the count of paths and values of unique IDs associated with the intermediate active nodes to be stored in accordance with the path dataset template 468.

Based on an active node associated with a probe node being a run-time node, the probe node may be a run-time probe node.

Notably, a generic node (for example, the generic node 302), a run-time node (for example, the run-time node 336), a generic probe node (for example, the generic probe node 402), and a run-time probe node (for example, the run-time probe node 426) when associated with an overlay node may be referred to as an executable generic node, an executable run-time node, an executable generic probe node, and an executable run-time probe node, respectively. An overlay associated with a node (for example, a generic node, a run-time node, a generic probe node, and a run-time probe node) may extend functionality thereof. An overlay node that has a node structure as described in conjunction with FIG. 3B may be a run-time overlay node. In other words, an overlay node having a node structure similar to the run-time node 336 may correspond to a runtime overlay node.

A node (for example, an active node, a probe node, or the like) when associated an overlay node is referred to as an executable node and may exhibit data as well as processing capability at run-time.

Based on an active node being a generic node, an associated probe node is a generic node. In addition, based on an active node being a run-time node, an associated probe node is a run-time node.

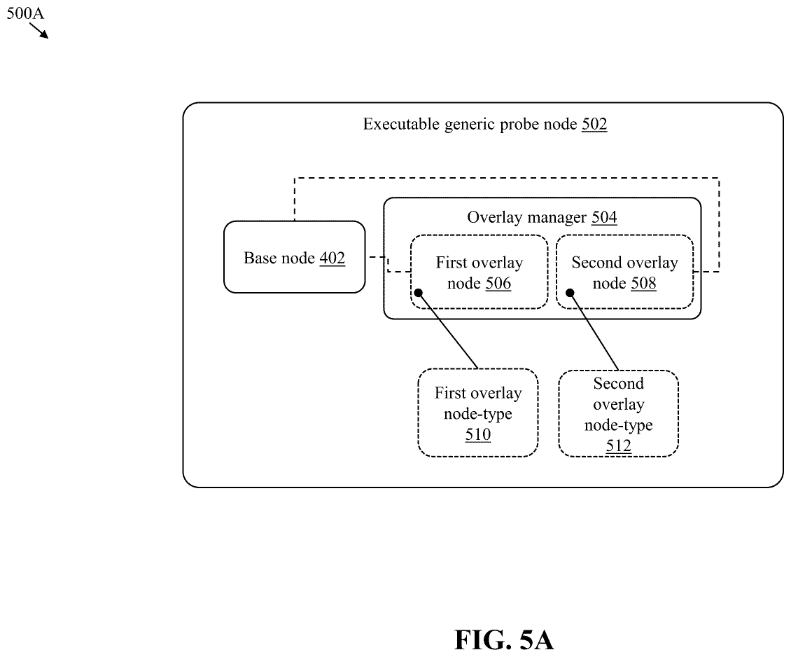

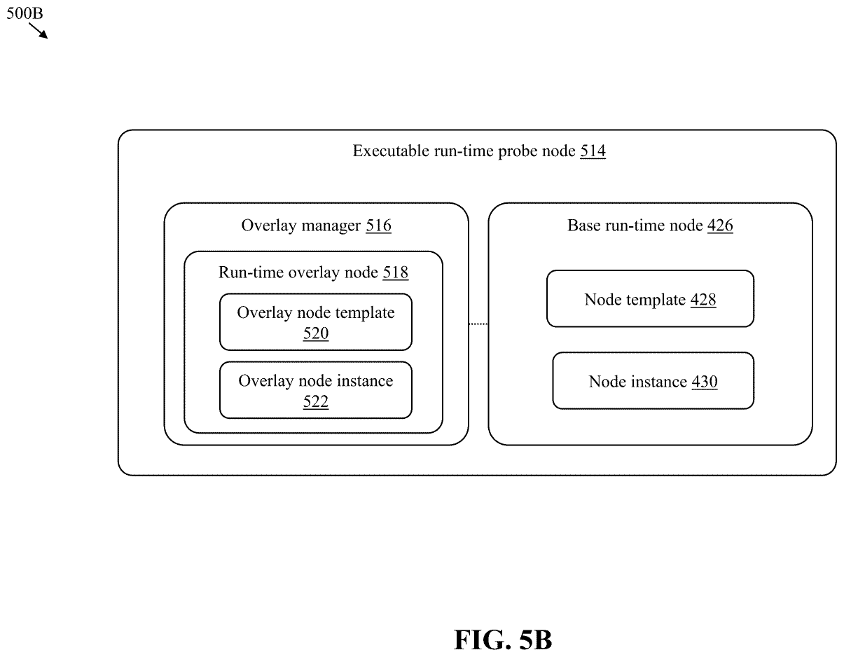

FIG. 5A is a block diagram 500A that illustrates an executable generic probe node 502 within the executable graph-based model 100, consistent with disclosed embodiments of the present disclosure. Referring to FIG. 5A, the executable generic probe node 502 is shown to include a base node (e.g., the generic probe node 402) and an overlay manager 504. For the sake of ongoing discussion, the base node corresponds to the generic probe node 402, and is hereinafter referred to as the “base node 402”. The base node 402 when extended by way of one or more overlay nodes becomes the executable generic probe node 502. The executable generic probe node 502 may have a first overlay node 506 and a second overlay node 508 associated therewith.

The overlay manager 504 registers and maintains one or more overlay nodes (such as the first and second overlay nodes 506 and 508) associated with the base node 402. The assignment of the first overlay node 506 and the second overlay node 508 to the base node 402 (via the overlay manager 504) endows the base node 402 with processing logic and executable functionality defined within the first and second overlay nodes 506 and 508.

The executable generic probe node 502 provides processing functionality (e.g., processing logic) to the base node 402 via one or more associated overlay nodes (for example, the first overlay node 506 and the second overlay node 508). Beneficially, the data and processing capability of the base node 402 may be dynamically and significantly extended using the concept of an executable node (for example, the executable generic probe node 502). As shown, the first overlay node 506 has a first overlay node-type 510 and the second overlay node 508 has a second overlay node-type 512. Therefore, the first overlay node 506 is associated with the first overlay node-type 510 and the second overlay node 508 is associated with the second overlay node-type 512. Examples of overlay node-types include, but are not limited to, a subscriber overlay node-type, a publisher overlay node-type, and an encryption overlay node-type.

A node with the subscriber overlay node-type is a subscriber overlay node that is indicative of an operation of receiving an input from an associated node. The subscriber overlay node also includes processing logic to receive the input. A node with the publisher overlay node-type is a publisher overlay node that is indicative of an operation of publishing an output of an associated node. The publisher overlay node also includes processing logic to publish the output. A node with the encryption overlay node-type is an encryption overlay node that is indicative of an encryption technique using which an associated node is to be secured. The encryption overlay node also includes processing logic to secure a corresponding node. Examples of the encryption technique include a symmetric encryption algorithm, an asymmetric encryption algorithm, a combination of these, or any other encryption technique.

Although, the executable generic probe node 502 is assumed to include the first and second overlay nodes 506 and 508, in other embodiments, the executable generic probe node 502 may include any number of overlay nodes, without deviating from the scope of the present disclosure.

The executable generic probe node 502 extends the base node 402 (or is a subtype of the base node 402) such that all the functionality and properties of the base node 402 are accessible to the executable generic probe node 502. The executable generic probe node 502 also dynamically extends the functionality of the base node 402 by associating the overlay nodes maintained by the overlay manager 504 with the base node 402. The executable generic probe node 502 may thus be considered a combination of the base node 402 and the first and second overlay nodes. The executable generic probe node 502 may be alternatively referred to as a node with overlay(s). Therefore, the executable generic probe node 502 acts as a decorator of the base node 402 adding the functionality of the overlay manager 504 to the base node 402.

It will be apparent to a person skilled in the art that the base node 402 refers to any suitable node within the executable graph-based model 100. As such, the base node 402 may be a generic node having a node-type such as a vertex node-type, an edge node-type, an overlay node-type, a role node-type, a combination of the edge node-type and the overlay node-type, or the like. Alternatively, the base node 402 may be an executable generic node or executable probe node such that the functionality of the (executable) base node 402 is dynamically extended. In this way, complex and powerful processing functionality can be dynamically generated by associating and extending overlay nodes.

Extending the functionality of a base node through one or more overlay nodes is at the heart of the overlay system 202. As illustrated in FIG. 2, the data and the functionality that acts upon that data (e.g., an overlay node) can be separated and independently maintained offline, but at run-time, an association between the data node and the overlay node is determined and an executable node is generated (e.g., the executable generic probe node 502 shown in FIG. 5A).

It will be apparent to a person skilled in the art that functionalities of the first and second overlay nodes 506 and 508 may be performed by a single overlay node that includes processing logic associated with both the first and second overlay nodes.

It will be apparent to a person skilled in the art that the list of overlay node-types is not exhaustive and the number of different overlay node-types that can be realized is not limited. Because an overlay node is itself a node, all functionality of a node described in relation to the base node 402 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the first overlay node 506 or the second overlay node 508, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 504 of the executable generic probe node 502 is responsible for executing all overlays registered therewith. The overlay manager 504 also coordinates the execution of all associated overlay nodes. As shown in FIG. 5A, the executable generic probe node 502 associates the base node 402 with two overlay nodes that is the first overlay node 506 and the second overlay node 508. Thus, the overlay manager 504 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 504 and are associated with an overlay via a node configuration extension for the overlay.

It will be apparent to a person skilled in the art that, in some embodiments, the base node may be a generic node (for example, the generic node 302) without deviating from the scope of the disclosure.

FIG. 5B is a block diagram 500B that illustrates an executable run-time probe node 514 within the executable graph-based model 100, consistent with disclosed embodiments of the present disclosure. Referring to FIG. 5B, the executable run-time probe node 514 is shown to include the run-time probe node 426 (hereinafter referred to as ‘the base run-time probe node 426’) and an overlay manager 516. The base run-time probe node 426 may be associated with a run-time overlay node 518. Hence, the overlay manager 516 may include the run-time overlay node 518. The executable run-time probe node 514 provides processing functionality (e.g., processing logic) to the base run-time probe node 426 via one or more associated overlay nodes (for example, the run-time overlay node 518). Beneficially, the data and processing capability of the base run-time probe node 426 may be dynamically and significantly extended using the concept of an executable run-time node (for example, the executable run-time probe node 514).

Although, the executable run-time probe node 514 is shown to include a single runtime overlay node 518, in other embodiments, the executable run-time probe node 514 may include any number of run-time overlay nodes. The run-time overlay node 518 may include an overlay node template 520 and an overlay node instance 522. The overlay node template 520 and an overlay node instance 522 may, collectively, constitute the run-time overlay node 518.

The executable run-time probe node 514 extends the base run-time probe node 426 (or is a subtype of the base run-time probe node 426) such that all the functionalities and properties of the base run-time probe node 426 may be accessible to the executable run-time probe node 514. The executable run-time probe node 514 also dynamically extends the functionality of the base run-time probe node 426 by associating the run-time overlay nodes maintained by the overlay manager 516 with the base run-time probe node 426. The executable run-time probe node 514 may thus be considered a composition of the base run-time probe node 426 and the run-time overlay node 518. The executable run-time probe node 514 may be alternatively referred to as a run-time node with overlay(s). Therefore, the executable run-time probe node 514 acts as a decorator of the base run-time probe node 426 adding the functionality of the overlay manager 516 to the base runtime probe node 426.

It will be apparent to a person skilled in the art that the base run-time probe node 426 refers to any suitable run-time node within the executable graph-based model 100. As such, the base run-time probe node 426 may be a run-time node having a node-type such as a vertex-node-type, an edge node-type, or the like. Alternatively, the base run-time probe node 426 may itself be an executable node such that the functionality of the (executable) base run-time probe node 426 is dynamically extended. In this way, complex and powerful processing functionality can be dynamically generated by associating and extending overlay nodes.

The overlay manager 516 registers and maintains one or more run-time overlay nodes (such as the run-time overlay node 518) associated with the base run-time probe node 426. The assignment of the run-time overlay node 518 to the base run-time probe node 426 (via the overlay manager 516) endows the base run-time probe node 426 with processing logic and executable functionality defined within the run-time overlay node 518. In other words, the run-time overlay node 518 may interact at run-time, with the node template 428 and/or the node instance 430 of the base run-time probe node 426. In an example, the node template 428 and the node instance 430 may be not executable nodes. That is, neither the node template 428 nor the node instance 430 comprises an overlay manager with one or more run-time overlay nodes. In another example, the node template 428 and/or the node instance 430 may be executable nodes thereby extending the functionality, complexity, and configurability of executable run-time nodes (for example, executable run-time nodes, and executable run-time probe nodes).

Extending the functionality of a base run-time node through one or more run-time overlay nodes is at the heart of the overlay system 202. As illustrated in FIG. 2, the data (e.g., a vertex node as represented by the base run-time probe node 426 in FIG. 4B) and the functionality that acts upon that data (e.g., an overlay node) can be separated and independently maintained offline, but at run-time, an association between the data node and the run-time overlay node is determined and an executable run-time node is generated (e.g., the executable run-time probe node 514).

Each run-time overlay node comprises an overlay node template and an overlay node instance. The overlay node template is a node template with the overlay node-type template. Similarly, the overlay node instance is a node instance with the overlay node-type instance. The overlay node instance is an implementation of the overlay node template. The overlay node template comprises one or more generic rules that may be implemented by the processing logic of the overlay node instance. For example, a rule may be defined in an overlay node template specifying that hashing algorithm is to be used and an overlay instance associated with the overlay template provides a specific implementation of a hashing algorithm (e.g., Message-Digest Algorithm 5 (MD5), Secure Hash Algorithm-1 (SHA-1), SHA-2, etc.).

A run-time overlay node, such as the run-time overlay node 518, is a node having an overlay node-type (alternatively referred to as an overlay type) assigned to its node-type. Examples of overlay node-types include an encryption overlay node-type, an obfuscation overlay node-type, an audit overlay node-type, an analytics overlay node-type, a handler overlay node-type, a publisher overlay node-type, or the like. It will be apparent to a person skilled in the art that the list of overlay types is not exhaustive and the number of different overlay types that can be realized is not limited.

Because an overlay node is itself a node, all functionality of a node described in relation to the base run-time probe node 426 is thus applicable to an overlay node. For example, an overlay node may include a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

A run-time overlay node, such as the run-time overlay node 518, is not bound to a single executable node or a single executable graph-based model (unlike nodes that have non-overlay node-types). This allows run-time overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays.

Unlike run-time nodes that are node run-time overlay nodes, a run-time overlay node may include processing logic (not shown in FIG. 5B) which determines the functionality of the run-time overlay node. The processing logic of a run-time overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 516 of the executable run-time probe node 514 is responsible for executing all overlays registered therewith. The overlay manager 516 also coordinates the execution of all associated overlay nodes. As shown in FIG. 5B, the executable run-time probe node 514 associates the base run-time probe node 426 with the run-time overlay node 518.

In some embodiments, the overlay manager 516 employs a strategy to manage potentially cascading execution flow of overlays such that one overlay may be associated with one or more other overlays. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies may be defined and registered with the overlay manager 516 and may be associated with an overlay via a node configuration extension for the overlay.

It will be apparent to a person skilled in the art that an executable run-time node may be implemented in a manner similar to the implementation of the executable run-time probe node 514 described in conjunction with FIG. 5B.

FIG. 6 is a block diagram 600 that illustrates a composition of the executable generic probe node 502 that enables persistent storage of data and processing logic associated therewith, consistent with disclosed embodiments of the present disclosure.

As described in conjunction with FIG. 5A, the executable generic probe node 502 includes the base node 402 and one or more overlay nodes (e.g., the first and second overlay nodes 506 and 508). For the brevity of the ongoing description, the persistent storage is explained for the executable generic probe node 502 including only the first overlay node 506. One or more operations performed for ensuring the persistence of the first overlay node 506 may be performed for the second overlay node 508 as well.

Referring to FIG. 6, the executable generic probe node 502 includes the base node 402 and the first overlay node 506. The executable generic probe node 502 has a corresponding first state 602 having a first ID 604. The base node 402 has a second state 606 having a second ID 608, and the first overlay node 506 has a third state 610 having a third ID 612. A manifest (for example, first through third manifests 614-618) is generated for each of the executable generic probe node 502, the base node 402, and the first overlay node 506. In an embodiment, the manifests may be generated by the storage management module 220. The first manifest 614 is associated with the executable generic probe node 502 and has a fourth ID 620 and an overlay ID 622. The second manifest 616 is associated with the base node 402 and has a fifth ID 624. The third manifest 618 is associated with the first overlay node 506 and has a sixth ID 626. Further, the manifests are stored at respective storage locations that may be centralized or distributed storage locations associated with the overlay system 202. The manifests may be stored by the storage management module 220.

The first state 602 of the executable generic probe node 502 includes data required to reconstruct the executable generic probe node 502 (e.g., attributes, properties, etc.). The first state 602 of the executable generic probe node 502 is persistently stored along with the first ID 604. The first manifest 614 is generated for the executable generic probe node 502 and has (i) the fourth ID 620 (which is the same as the first ID 604), (ii) the storage location of the first state 602 of the executable generic probe node 502, and (iii) the overlay ID 622 (which is the same as the sixth ID 626). Notably, the fourth ID 620 is the same as the first ID 604 and the fifth ID 624, hence, the first manifest 614 includes the ID of the state of the base node 402 and the executable generic probe node 502. Further, the overlay ID 622 is the same as the sixth ID 626 of the state of the first overlay node 506. Therefore, the first manifest 614 may be used to identify and retrieve the states of the base node 402, the executable generic probe node 502, and the first overlay node 506. Subsequently, the retrieved states may be used to reconstruct the executable generic probe node 502 and the first overlay node 506. In an instance, the executable generic probe node 502 may be further extended to include additional overlay nodes. In such an instance, the first manifest 614 may include state IDs of the additional overlay nodes as well. A first manifest state (not shown) is then generated for the first manifest 614 and persistently stored along with the fourth ID 620.

The second state 606 of the base node 402 includes data required to reconstruct the base node 402 (e.g., attributes, properties, etc.) and is persistently stored along with the second ID 608. The second manifest 616 is generated for the base node 402 and has the fifth ID 624 and the storage location of the second state 606 of the base node 402. The second ID 608 of the second state 606 and the fifth ID 624 of the second manifest 616 are the same as the first ID 604 of the first state 602 of the executable generic probe node 502 (which is also the same as the fourth ID 620 of the first manifest 614 of the executable generic probe node 502). As mentioned above, along with the first state 602, the first manifest 614 may also be used to identify and retrieve the second manifest 616 which in turn may be used to identify the second state 606 of the base node 402. A second manifest state (not shown) is then generated for the second manifest 616 and persistently stored along with the fifth ID 624. Thus, the states, manifests, and manifest states for the executable generic probe node 502 and the base node 402 include the same, shared, ID. A shared ID can be used in this instance because the states, manifests, and manifest states are stored separately. The separate storage of the states, manifests, and manifest states exhibit a distributed architecture of the overlay system 202.

The third state 610 of the first overlay node 506 includes data required to reconstruct the first overlay node 506 (e.g., attributes, properties, processing logic, etc.) and is persistently stored along with the third ID 612. The third manifest 618 is generated for the first overlay node 506 and includes the sixth ID 626, which is the same as the third ID 612. Therefore, the first manifest 614 may be further used to identify and retrieve the third manifest 618 which in turn may be used to identify and retrieve the third state 610 of the first overlay node 506. A third manifest state (not shown) is then generated for the third manifest 618 and is persistently stored along with the sixth ID 626.

In operation, when the executable generic probe node 502 is to be loaded, the transaction module 208, in conjunction with the storage management module 220, may execute one or more operations to retrieve the first manifest state stored at a known storage location. Based on the first manifest state, the storage management module 220 may re-construct the first manifest 614 which includes the fourth ID 620 which is the same as the fifth ID 624 of the second manifest 616. Based on the fifth ID 624, the storage management module 220 may identify the second manifest state and may generate the second manifest 616 based on which the second state 606 is identified. Subsequently, the base node 402 is loaded and the storage management module 220 may determine that the base node is a node with overlay. Based on the fourth ID 620 (that is the same as the first ID 604 of the first state 602 of the executable generic probe node 502) of the first manifest 614, the first state 602 is identified and retrieved. Subsequently, the executable generic probe node 502 is loaded. Moreover, based on the overlay ID 622 (that is the same as the sixth ID 626 of the third manifest 618) of the first manifest 614, the third manifest state is identified and the third manifest 618 is generated. Subsequently, based on the sixth ID 626 (that is the same as the third ID of the third state) of the third manifest 618, the third state 610 is identified and retrieved. Based on the third state 610, the first overlay node 506 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 624. Based on the determined ID, the processing logic (such as the memory management module 218 and the storage management module 220) may identify the second manifest 616. Subsequently, the processing logic (such as the memory management module 218 and the storage management module 220) may identify the second state 606 that has the second ID 608 that matches the fifth ID 624. Further, the processing logic (such as the memory management module 218 and the storage management module 220) may retrieve the second state 606 associated with the second manifest 616 from a corresponding storage element. Subsequently, the processing logic (such as the memory management module 218 and the storage management module 220) may determine, by checking the manifest storage(s) associated with the overlay system 202, whether there is another manifest (such as the first manifest of the executable generic probe node 502) with an ID that matches the second ID 608 and the fifth ID 624. Notably, the first manifest 614 includes storage locations of each overlay node (for example, the first overlay node 506) of the executable generic probe node 502. Based on the overlay ID 622 included in the first manifest 614 that matches the sixth ID 626 included in the third manifest 618, the processing logic (such as the memory management module 218 and the storage management module 220) may identify and retrieve the third manifest 618 from a manifest storage of a plurality of manifest storages of the overlay system 202. Subsequently, the processing logic (such as the memory management module 218 and the storage management module 220) may identify the third state 610 which has the third ID 612 that matches the sixth ID 626. Further, the processing logic (such as the memory management module 218 and the storage management module 220) may retrieve the third state 610 associated with the third manifest 618 from a corresponding storage element. To determine whether the first overlay node 506 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 626. Since the first overlay node 506 does not have an overlay associated therewith, no other manifest has the ID that matches the sixth ID 626.

Notably, the manifest (the third manifest 618) of the first overlay node 506 includes a reference (such as an identifier that is common to the second manifest 616 and the third manifest 618, a link, a path, a storage location, or the like) to the second manifest 616 of the base node 402. Therefore, the re-formation of the executable generic probe node 502 includes a re-creation of the first overlay node 506 prior to a re-creation of the base node 402. Subsequently, the first overlay node 506 and the base node 402 are organized by associating the base node 402 with the first overlay node 506 to re-form the executable generic probe node 502.

In some embodiments, the first overlay node 506 may not be loaded in case it is not required for executing the operation associated with the stimulus 230. The loaded executable generic probe node 502 and the first overlay node 506 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 6 illustrates only a single overlay node associated with a probe node, in other embodiments, the executable generic probe node 502 may include additional or different overlay nodes. It will also be apparent to a person skilled in the art that only those overlay nodes that are required for responding to the stimulus 230 may be loaded.

It will be apparent to a person skilled in the art that a generic node (for example, the generic node 302) may also be loaded in a manner similar to the loading of the base node 402. Similarly, an executable generic node may be loaded in a manner similar to the loading of the executable generic probe node 502.

In some embodiments, the run-time node 336 may be loaded by loading the node template 338 and the node instance 340. Each of the node template 338 and the node instance 340 of the run-time node 336 may be loaded in a manner similar to the loading of the base node 402. Additionally, in an instance when the run-time node 336 may be extended by way of a run-time overlay node, the node template 338 and the node instance 340 may be associated with overlay node template and overlay node instance, respectively, of the run-time overlay node. In such a scenario, each of the node template 338 and the node instance 340 may be loaded in a manner similar to the loading of the executable generic probe node 502. Additionally, a run-time probe node (for example, the run-time probe node 426) may also be loaded in a manner similar to the loading of the run-time node 336.

Notably, a probe node (for example, the generic probe node 402 and the run-time probe node 426) may be a stateful node or a stateless node. Based on the probe node being the stateful node, a state of the probe node persists in the storage element of the overlay system 202 upon unloading thereof. The state of the probe node may be used to re-generate/load the probe node in the executable graph-based model 100 based on a requirement thereof. Based on the probe node being the stateful node, an intersection point and/or a path (namely, a connection link), that may have been determined based on the said probe node, may persist in the overlay system 202 upon unloading of the probe node. Further, based on the probe node being the stateless node, the state of the probe node may cease to exist in the storage element upon unloading thereof from the executable graph-based model 100. That is to say that, the probe node may be discarded from the overlay system 202 based on the unloading thereof. Based on the probe node being the stateless node, an intersection point and/or a path that may have been determined based on the said probe node may cease to persist in the overlay system 202 upon unloading of the probe node.

Having discussed various structural features and operational constraints associated with the overlay system 202, the description now moves towards implementation of the plurality of probe nodes in conjunction with the plurality of active nodes while leveraging the structural features and the operational constraints of the overlay system 202.

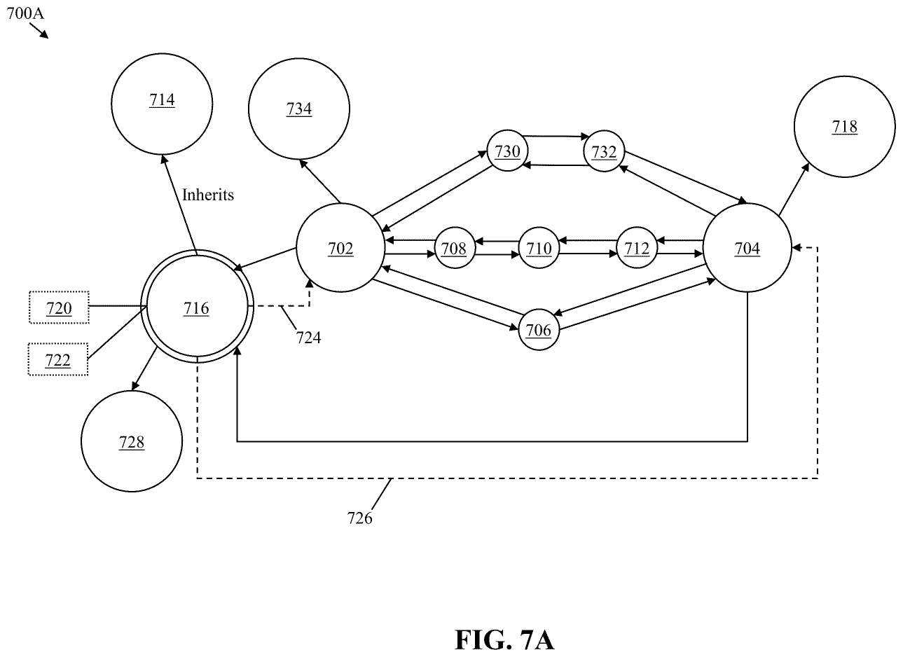

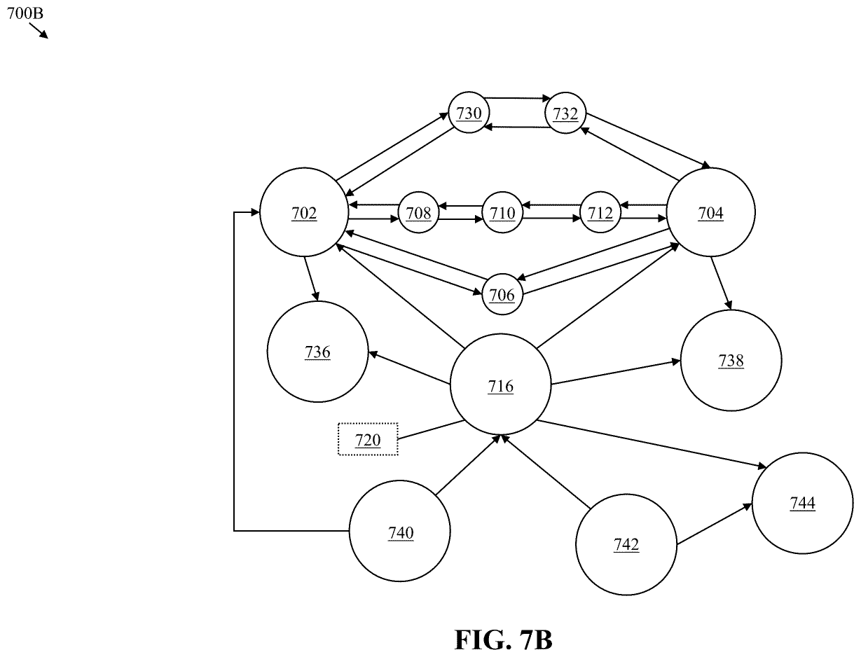

FIGS. 7A and 7B illustrate graphs 700A and 700B, respectively, that, collectively, depict scenarios for implementation of the plurality of probe nodes in conjunction with a plurality of generic nodes of the executable graph-based model 100, consistent with disclosed embodiments of the present disclosure. Referring to FIG. 7A, the graph 700A is shown to include a plurality of active nodes that are generic nodes and a plurality of probe nodes that are associated with the plurality of active nodes and are generic probe nodes. The plurality of active nodes may include, but are not limited to, active nodes 702-712. Each active node of the plurality of active nodes may be associated with one or more other active nodes of the plurality of active nodes by way of a set of active nodes acting as intermediate active nodes. The intermediate active nodes may be active nodes with an edge node-type (for example, the edge node-type 330). In other words, the intermediate active nodes may be edge nodes. In addition, the intermediate active nodes may form a connection link (namely, a path) between two or more active nodes. An intermediate active node of the intermediate active nodes may be selected as an intersection node that is associated with each active node of the two or more active nodes and may be used to access each active node of the two or more active nodes. Such determination of the path and the intersection node associated with the two or more active nodes may be performed based on the plurality of probe nodes of the executable graph-based model 100. As shown, the plurality of probe nodes include, but are not limited to, probe nodes 714-718. Each probe node of the plurality of probe nodes may be associated with at least one active node by way of a direct connection or an indirect connection. For example, the probe node 716 is associated with the active node 702.

In a scenario when a first active node and a second active node of the plurality of active nodes may be associated based on an indirect connection, an intersection node associated with each of the first and second active nodes may be determined. The intersection node may be a point of commonality between the first and the second active nodes. The point of commonality may correspond to an active node that may be associated with each of the first and second active nodes and may be used to directly or indirectly access the first and second active nodes. The probe node may be used to perform a path detection operation for determining the intersection node. In addition, the path detection operation may also be performed for various purposes such as graph traversal optimization, indexing, graph partitioning, dynamic graph monitoring, graph compression, parallelization and distribution, cost-based optimization, or the like.

In operation, the processing circuitry (for example, the controller module 206, the transaction module 208, the stimuli management module 212, or the like) may be configured to receive a stimulus (for example, the stimulus 230) associated with the overlay system 202. The stimulus may be indicative of determination of an intersection node associated with the active nodes 702 and 704 of the executable graph-based model 100. Based on a context of the stimulus, the processing circuitry (for example, the controller module 206, the transaction module 208, the stimuli management module 212, or the like) may be configured to identify the active nodes 702 and 704 in the executable graph-based model 100. The active nodes 702 and 704 may be a vertex node, an edge node, an overlay node, or a role node. The active nodes 702 and 704 may be associated with each other by way of an indirect connection link (namely, a path) formed by one or more intermediate active nodes that may be directly or indirectly associated with each of the active nodes 702 and 704.

Based on the identification of the active nodes 702 and 704, the processing circuitry (for example, the controller module 206, the transaction module 208, the stimuli management module 212, the probe node management module 236, or the like) may be configured to determine the probe node 716 associated with the active node 702. The probe node 716 may have a node-type that may be a combination of an edge node-type and an overlay node-type. The probe node 716 may be associated with an active node (for example, the active node 702) based on the node-type including the edge node-type. In addition, the probe node 716 may implement a probing technique 720 based on the node-type including the overlay node-type. The probing technique 720 may be indicative of a path detection algorithm to be executed for determination of one or more paths/connection links that associate the active node 702 with one or more active nodes of the plurality of active nodes. The probe node 716 may be further associated with a path dataset 722 that may be indicative of a set of intermediate active nodes that form various paths that associate the active node 702 with the one or more active nodes of the plurality of active nodes. In some embodiments, the path dataset 722 may include unique IDs of the set of intermediate active nodes. In addition, for each intermediate active node, the path dataset 722 may also include unique IDs of active nodes that are associated with the active node 702 by way of that intermediate active node.

The probe node 716 may be a public access node, a private access node, or a protected access node. Based on the probe node 716 being a public access node of the executable graph-based model 100, the probe node 716 is accessible to all entities or users within the overlay system 202. Based on the probe node 716 being a private access node, the probe node 716 is restricted to be accessible and used by specific users or entities associated with the overlay system 202. Only authorized users or processes can access or interact with the private access node. Based on the probe node 716 being a protected access node falls between public and private access nodes. It is partially restricted, meaning the probe node 716 may be accessible to certain users or under specific conditions. The protected access node may have controlled permissions, such as read-only access for some users while allowing modifications by others.

In some embodiments, the probe node 716 may be an automated probe node. An automated probe node may be executed by the processing circuitry (for example, the controller module 206, the transaction module 208, the stimuli management module 212, the probe node management module 236, or the like) for one or more operations associated with the overlay system 202. The automated probe node may not require an external input for execution thereof. In such a scenario, the stimulus may be an internal stimulus that may be generated by one or more modules (shown in FIG. 2) of the overlay system 202.

In some embodiments, the probe node 716 may be a manual probe node A manual probe node may be executed by the processing circuitry (for example, the controller module 206, the transaction module 208, the stimuli management module 212, the probe node management module 236, or the like) based on the stimulus received as an input by the overlay system 202. The stimulus may be an external stimulus.

Subsequently, based on the identification of the active nodes 702 and 704 and the determination of the probe node 716, the processing circuitry (for example, the controller module 206, the transaction module 208, the memory management module 218, the storage management module 220, or the like) may be configured to determine whether the active nodes 702 and 704, and the probe node 716 are unloaded from the executable graph-based model 100. Based on determination of at least one of the active nodes 702 and 704, or the probe node 716 being unloaded from the executable graph-based model 100, the processing circuitry (for example, the controller module 206, the transaction module 208, the memory management module 218, the storage management module 220, or the like) may be configured to load at least one of the active nodes 702 and 704, or the probe node 716 in the executable graph-based model 100.

The processing circuitry (for example, the controller module 206, the transaction module 208, the stimuli management module 212, the probe node management module 236, or the like) may be further configured to execute a path detection operation based on the active nodes 702 and 704, and the probe node 716. In other words, the processing circuitry (for example, the controller module 206, the transaction module 208, the stimuli management module 212, the probe node management module 236, or the like) may be further configured to use the probe node 716 to execute the path detection operation based on the active nodes 702 and 704.

In some embodiments, the probe node 716 may be associated with an overlay node 728 of a plurality of overlay nodes of the executable graph-based model 100. In such embodiments, the path detection operation may be executed further based on the overlay node 728. In an example, the overlay node 728 may be an encryption overlay node and may have an encryption logic that may have been used to encrypt the probe node 716. Therefore, while executing the path detection operation a decryption logic of the overlay node 728 may be used by the processing circuitry (for example, the controller module 206, the transaction module 208, the probe node management module 236, the overlay management module 238, or the like) to decrypt the probe node 716. In another example, the overlay node 728 may be a contract overlay node that may implement a set of constraints to perform access control associated with the probe node 716.

For further execution of the path detection operation, the processing circuitry (for example, the controller module 206, the transaction module 208, the stimuli management module 212, the probe node management module 236, or the like) may be further configured to use the probe node 716 to associate a first anchor point (shown by a dashed arrow 724) with the active node 702 and a second anchor point (shown by a dashed arrow 726) with the active node 704. The first anchor point may be indicative of a source node and the second anchor point may be indicative of a destination node, for the path detection operation. The probe node 716 may use the first and second anchor points as a guide rail to traverse from the active node 702 to 704 and/or vice versa.

In some embodiments, by way of implementation of on the probing technique 720, the processing circuitry (for example, the controller module 206, the transaction module 208, the stimuli management module 212, the probe node management module 236, or the like) may be configured to use the path dataset 722 to determine each intermediate active node that associates the active node 702 with the active node 704. In some embodiments, such associations may have a single degree of correlation meaning that such associations may be made of a single intermediate active node. The processing circuitry (for example, the controller module 206, the transaction module 208, the stimuli management module 212, the probe node management module 236, or the like) may use the path dataset 722 to determine an intermediate active node 706 that associates the active node 702 with the active node 704 with the single degree of correlation. In some instances, such a path may not exist or may not be optimal in terms of cost of traversal from the active node 702 to the active node 704, time required for the traversal, or processing required for the traversal.

Therefore, the processing circuitry (for example, the controller module 206, the transaction module 208, the stimuli management module 212, the probe node management module 236, or the like) may use the probe node 716 in conjunction with the path dataset 722 to traverse through the intermediate active nodes listed in the path dataset 722. The traversal may be performed in accordance with the probing technique 720. Each intermediate node is analyzed, and active nodes directly or indirectly connected to it are checked until an active node with a unique ID matching the active node 704 is located. This traversal process may result in multiple possible paths between the active nodes 702 and 704.

The processing circuitry (for example, the controller module 206, the transaction module 208, the stimuli management module 212, the probe node management module 236, or the like) may evaluate the paths based on a set of optimality criteria such as shortest distance, lowest cost, minimal latency, or highest efficiency, depending on a requirement associated with the overlay system 202. A ranked list of paths is then generated, prioritizing the most optimal connections. This ensures efficient routing and decision-making within the executable graph-based model 100.

A first path that may be first on the ranked list of paths may include intermediate active nodes 730 and 732 such that the intermediate active node 730 may be associated with the active node 702 and the intermediate active node 732 while the intermediate active node 732 may be associated with the active node 704 and the intermediate active node 730. In such an instance, the intermediate active node 732 that is directly associated with the active node 704 and indirectly associated with the active node 702 may be selected as an intersection node (hereinafter, the intersection node 732). In scenarios, when the intersection node 732 may be an accessible node and may be accessed based on the stimulus, a query, message, instruction, or the like may be generated and executed based on the active nodes 702 and 704 by way of the intersection node 732. Alternatively, in scenarios, when the intersection node 732 may be an inaccessible node, an alternative intersection node may have to be determined. The intersection node 732 may be the inaccessible node when the probe node 716 may not have permission to access the intersection node 732 which may be a private node or a protected node.

The processing circuitry (for example, the controller module 206, the transaction module 208, the stimuli management module 212, the probe node management module 236, or the like) may determine the alternative intersection node based on a second path that may be second on the ranked list of paths. The second path may include intermediate active nodes 708, 710, and 712. The second path may be formed by the intermediate active node 708 being associated with the active node 702 and the intermediate active node 710, the intermediate active node 710 being associated with the intermediate active nodes 708 and 712, and the intermediate active node 712 being associated with the active node 704 and the intermediate active node 710. Based on the second path, the processing circuitry (for example, the controller module 206, the transaction module 208, the stimuli management module 212, the probe node management module 236, or the like) may determine the intermediate active node 710 as the alternative intersection node that may be indirectly associated with the active nodes 702 and 704. The intermediate active node 710 may be used to process a query, message, instruction, or the like associated with the active nodes 702 and 704.

Notably, the above-discussed path detection operation is a unidirectional path detection operation. That is to say that, each path on the ranked list of paths is determined from the active node 702 to the active node 704. In other words, each path is determined from a source to a destination.

In some embodiments, the path detection operation may be a bi-directional path detection operation. In such embodiments, each path is detected from the active node 702 to the active node 704 and vice versa. In other words, for detection of each path, two separate traversals (such as, from the active node 702 to the active node 704 and from the active node 704 to the active node 702) are performed. That is to say that, each path is determined from a source to a destination or from the destination to the source. Each traversal is performed as described in conjunction with detection of the ranked list of paths for the unidirectional path detection operation.

In some embodiments, a path from the active node 704 to the active node 702 may be traversed based on the probe node 718 associated with the active node 704. In such an embodiment the processing circuitry (for example, the controller module 206, the transaction module 208, the stimuli management module 212, the probe node management module 236, or the like) may use the probe nodes 718 and 716 to determine the intersection node.

In some embodiments, the probe node 716 may be further associated with the active node 704. In such embodiments, the path dataset 722 may further include a count of intermediate active nodes and unique IDs of the intermediate active nodes directly or indirectly associated with the active node 704. The path dataset 722 may be further used to traverse various paths/connection links from the active node 704 to the active node 702. The paths may be determined by way of implementation of the probing technique 720 and/or any other probing technique associated with the probe node 716. The intersection node (for example, the intermediate active node 710) may be determined based on an intersection of the two separate traversals of paths. For example, while traversing from the active node 704 to the active node 702 and from the active node 702 to the active node 704, the intermediate active nodes 708, 710, and/or 712 may be common active nodes. Therefore, one of the intermediate active nodes 708, 710, and/or 712 may be determined as the intersection node.

In some embodiments, the intersection node may be determined based on a comparison of the intermediate active nodes 708, 710, and/or 712 for a set of parameters. The set of parameters may include (i) a cost of traversal between the active node 702 and the active node 704 from each of the intermediate active nodes 708, 710, and/or 712, (ii) time required for a traversal between the active node 702 and the active node 704 from each of the intermediate active nodes 708, 710, and/or 712, or (iii) processing requirement for the traversal between the active node 702 and the active node 704, via each of the intermediate active nodes 708, 710, and/or 712. The probing technique 720 may be referred to as a first probing technique. A cost of traversal between two active nodes may correspond to various resources, nodes, or the like to be used while traversing from one active node to another active node. Time required for traversal between two active nodes may correspond to time complexity associated with traversal from one active node to another active node. In other words, the time required for traversal between two active nodes may correspond to time spent while traversing from the one active node to the another active node. Processing required for traversal between two active nodes may correspond to processing complexity associated with traversal from one active node to another active node. In other words, the processing required for traversal between two active nodes may correspond to processing associated with operations to be executed while traversing from the one active node to the another active node.

In some embodiments, the probe node 716 may be further associated with a second probing technique. In such embodiments, a first intersection node (for example, the intermediate active node 710) may be determined by way of implementation of the first probing technique, and a second intersection node (for example, the intermediate active node 712) may be determined by way of implementation of the second probing technique. The processing circuitry (for example, the controller module 206, the transaction module 208, the stimuli management module 212, the probe node management module 236, or the like) may be configured to compare the first intersection node and the second intersection node for a set of parameters. The set of parameters may include (i) a cost of traversal between the active node 702 and the active node 704 from the first intersection node and the second intersection node, (ii) time required for a traversal between the active node 702 and the active node 704 from the first intersection node and the second intersection node, or (iii) processing requirement for the traversal between the active node 702 and the active node 704 from the first intersection node and the second intersection node. One of the first intersection node and the second intersection node having at least one of a lowest cost of traversal, minimum time required for the traversal, or minimum processing requirement for the traversal, from the active node 702 to the active node 704 may be selected as an optimal intersection node. The optimal intersection node may be used for one or more operations to be executed based on the active nodes 702 and 704.

In some embodiments, the active node 702 may be further associated with a probe node 734 implementing a third probing technique. The processing circuitry (for example, the controller module 206, the transaction module 208, the stimuli management module 212, the probe node management module 236, or the like) may be configured to determine a first and a second intersection node using the probe nodes 716 and 734, respectively. The first and second intersection nodes may be compared for the set of parameters as discussed above to determine an optimal intersection node.

In some embodiments, the probe node 716 may inherit from the probe node 714. Based on the probe node 716 inheriting the probe node 714, the probe node 716 may access a path dataset and probing technique associated with the probe node 714. The path dataset and the probing technique inherited from the probe node 714 may be used by the probe node 716 to determine additional intersection nodes that may be compared with the intermediate active node 710 for the set of parameters to determine the optimal intersection node.

Notably, an intermediate active node may correspond to an edge node. Therefore, the intersection node, the alternative intersection node, and the optimal intersection node are also edge nodes.

In some embodiments, the probe node 716 may be the stateful node. Based on the probe node 716 being the stateful node, upon unloading of the probe node 716, the determination of the intermediate active node 710 as the intersection node associated with the active nodes 702 and 704 may persist in the storage element of the overlay system 202 in association with a node state of the probe node 716. Notably, such determination of the intersection node may be stored in conjunction with a node state of the probe node 716 and hence may be accessed by loading the probe node as described in conjunction with FIG. 6.

In some embodiments, the probe node 716 may be the stateless node. Based on the probe node 716 being the stateless node, upon the unloading of the probe node 716, the determination of the intermediate active node 710 as the intersection node associated with the active nodes 702 and 704 may cease to exist in the overlay system 202.

It will be apparent to a person skilled in the art that probing techniques used to perform the path detection operation described herein are exemplary and do not limit the scope of the disclosure. In other embodiments, the probing technique may be implemented based on modification and customization of any path detection algorithm, known in the art, to adhere to the structure and constraints of the overlay system 202.

Referring now to FIG. 7B, shown are the plurality of active nodes including the active nodes 702 and 704 that are generic nodes. As mentioned previously, the active nodes 702 and 704 are associated with the probe node 716. In some embodiments, the probe node 716 may be a composite node of the executable graph-based model 100. The composite node may correspond to a combination of two or more probe nodes. The composite node may own the two or more probe nodes and may act as a parent to the two or more probe nodes and the two or more probe nodes may be child nodes of the composite node. In such an embodiment, the probe node 716 may be a combination of probe nodes 736 and 738. The path detection operation may be executed further based on at least one of the probe nodes 736 and 738 that may be associated with the active node 702 and/or the active node 704 based on association of the probe node 716 with the active nodes 702 and 704. The path detection operation may be executed based on the probe nodes 736 and 738 implementing corresponding probing techniques. As shown, the probe node 736 is associated with the active node 702 and the probe node 738 is associated with the active node 704. The bi-directional path detection operation may be performed such that the probe node 736 may determine paths from the active node 702 to the active node 704 and the probe node 738 may determine paths from the active node 704 to the active node 702.

In some embodiments, the probe node 716 may not be associated with a probing technique and each of the probe nodes 736 and 738 may be associated with corresponding probing techniques. Therefore, the determination of paths, from the active node 702 to the active node 704, based on the probe node 736 may be performed by way of implementation of the probing technique associated with the probe node 736. Similarly, the determination of paths, from the active node 704 to the active node 702, based on the probe node 738 may be performed by way of implementation of the probing technique associated with the probe node 738.

In some embodiments, the probe node 716 may be associated with the first probing technique. Based on the probe nodes 736 and 738 being included in the probe node 716, the processing circuitry (for example, the controller module 206, the transaction module 208, the probe node management module 236, or the like) may be configured to associate the first probing technique with the probe nodes 736 and 738. In such embodiments, the determination of paths based on the probe nodes 736 and 738 may be performed by way of implementation of the first probing technique by the probe nodes 736 and 738. Notably, based on the probe nodes 736 and 738 being included in the probe node 716, the path detection operation executed by the probe nodes 736 and 738 corresponds to the path detection operation executed by the probe node 716.

In some embodiments, the probe node 716 may be associated with the probing technique 720 and the probe node 736 may also have an associated probing technique. However, the probe node 738 may have an absence of an associated probing technique. Based on the probe node 738 being included in the probe node 716, the processing circuitry (for example, the controller module 206, the transaction module 208, the probe node management module 236, or the like) may be configured to associate the probing technique 720 with the probe node 738. Therefore, the determination of paths based on the probe node 736 may be performed by way of implementation of the probing technique associated with the probe node 736. Similarly, the determination of paths based on the probe node 738 may be performed by way of implementation of the probing technique 720 associated with the probe node 738.

In some embodiments, the probe nodes 736 and 738 may be composite nodes. Hence each of the probe nodes 736 and 738 may include two or more probe nodes that may be used for executing path detection operation based on the probe node 716 as described throughout the description. In other words, each of the probe nodes 736 and 738 may be a combination of two or more probe nodes that may be used for executing path detection operation based on the probe node 716.

In some embodiments, the probe node 716 may be included in probe nodes 740 and 742 which may be composite nodes. The probe node 740 may be associated with the active node 702. In such embodiments, the probe node 716 may be associated with the active node 702 based on association of the probe node 740 with the active node 702. The probe node 742 may be associated with an active node 744 and the probe node 716 may also be associated with the active node 744 based on the probe node 716 being included in the probe node 742.

When executed in association with the probe node 742, the probe node 716 may implement a third probing technique to execute a path detection operation based on the active node 744. In addition, when executed in association with the probe node 740, the probe node 716 may implement the probing technique 720, which may be associated with the probe node 740, and may execute that path detection operation based on the active node 702. Therefore, the probe node 716 may have a plurality of parent nodes and the probe node 716 may implement a probing technique configured for a first parent node when it may be executed in association with the first parent node. A probing technique may be configured for the parent node based on association of the probing technique with at least one of the child node and the parent node. In an example, a probing technique associated with a parent node may be configured to be implemented by each child node of the parent node. In another example, a first probing technique may be configured to be implemented by a child node instead of a second probing technique associated with the parent node.

Having discussed implementation of the plurality of probe nodes with the generic nodes, the description now moves towards implementation of the plurality of probe nodes with runtime nodes.

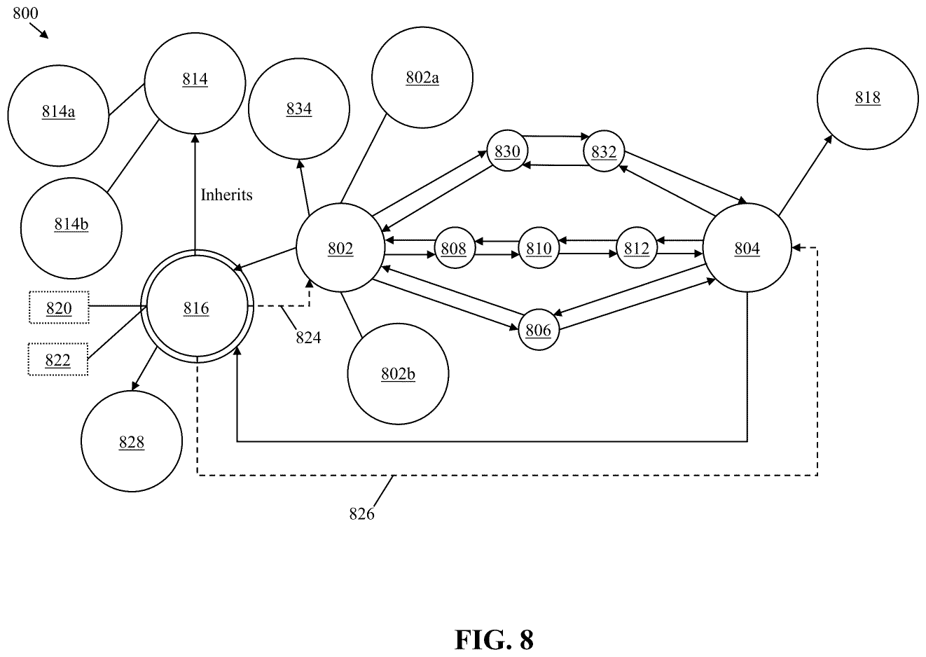

FIG. 8 illustrates a graph 800 that depicts implementation of the plurality of probe nodes in conjunction with a plurality of run-time nodes of the executable graph-based model 100, consistent with disclosed embodiments of the present disclosure. Referring to FIG. 8, shown are a plurality of active nodes that may be run-time nodes and the plurality of probe nodes that may be run-time probe nodes. The plurality of active nodes may include active nodes 802-812 and the plurality of probe nodes include probe nodes 814-818. Each active node being a run-time node may include a node template and a node instance as described in conjunction with FIG. 3B. For example, the active node 802 may include a node template 802a and a node instance 802b. Based on the active node being run-time nodes, the probe nodes may be run-time probe nodes. Therefore, each probe node may include a probe node template (for example, the node template 428) and a probe node instance (for example, the node instance 430). A node template of a probe node may correspond to a probe node template whereas a node instance of a probe node may correspond to a probe node instance. For example, a probe node 814 may include a probe node template 814a and a probe node instance 814b.

The active node 802 is shown to be associated with the probe nodes 814, 816, and 834. The active node 804 is shown to be associated with the probe nodes 816 and 818. The active nodes 802-804 may have descriptions and embodiments that may be similar to the description and embodiments of the active nodes 702-704, respectively. The probe nodes 814-818 may have descriptions and embodiments that may be similar to the description and embodiments of the probe nodes 714-718, respectively. The probe node 834 may have a description similar to the description of the probe node 734. The active nodes 802 and 804 may be associated by way of intermediate active nodes 806-812 and the intermediate active nodes 830-832. The intermediate active nodes 806-812 may have a description similar to the description of the intermediate active nodes 706-712, respectively. The intermediate active nodes 830-832 may have a description similar to the description of the intermediate active nodes 730-732, respectively. The probe node 816 is associated with a probing technique 820 and a path dataset 822 having descriptions similar to the descriptions of the probing technique 720 and the path dataset 722, respectively. The probe node 816 is further configured to associate a third anchor point (shown by way of a dashed arrow 824) with the active node 702 and a fourth anchor point (shown by way of a dashed arrow 826) with the active node 704. The third anchor point may have a description similar to the first anchor point and the fourth anchor point may have a description similar to the second anchor point. The probe node 816 is associated with a run-time overlay node 828 that may have a description similar to the overlay node 728. The processing circuitry (for example, the controller module 206, the transaction module 208, the stimuli management module 212, the probe node management module 236, or the like) may use the probe node 816 to execute a path detection operation based on the active nodes 802 and 804 to determine an intersection node as described in conjunction with FIGS. 7A and 7B.

In some embodiments, the probe node 816 may be the composite node. In such embodiments, various embodiments and concepts described in conjunction with FIG. 7B for the probe node 716 may also be applicable to the probe node 816.

In addition, a run-time node (for example, the active nodes 802 and 804, the probe node 816, the run-time overlay node 828, or any other run-time node of the executable graph-based model 100) may be loaded based on loading of a corresponding node template and a corresponding node instance as described in conjunction with FIG. 6.

It will be apparent to a person skilled in the art that in some embodiments the probing technique 820 may be different from the probing technique 720 and may apply any graph traversal technique that may be modified to adhere to structure and constraints associated with the overlay system 202.

Having discussed various concepts associated with implementation and application of the probe nodes to find an intersection node between a pair of active nodes (for example, the active nodes 702-704 and the active nodes 802-804) of the executable graph-based model 100, the description now moves towards implementation of a probe node to determine an intersection node between three or more active nodes.

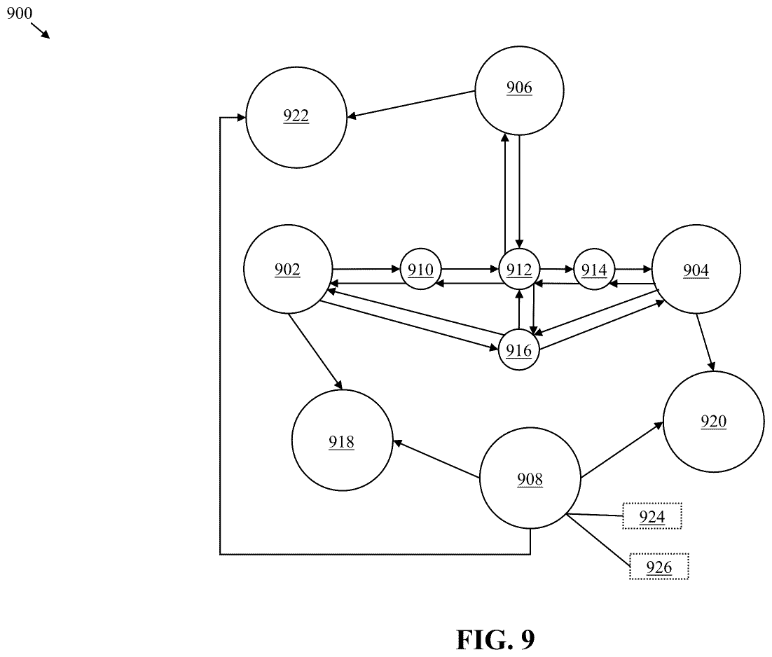

FIG. 9 illustrates a graph 900 that depicts implementation of probe nodes for performing a path detection operation associated with three or more active nodes, consistent with disclosed embodiments of the present disclosure. Referring to FIG. 9, show are the plurality of active nodes including the active nodes 902, 904, and 906 that may be generic nodes or run-time nodes. The active nodes 902, 904, and 906 may be mutually associated by way of intermediate active nodes including intermediate active nodes 910-916. The graph 900 further includes a probe node 908 that may be the composite node and may include probe nodes 918-922.

The probe node 908 may be associated with a probing technique 924 and a path dataset 926. The probing technique 924 may be implemented by each of the probe nodes 918-922 that may not have a corresponding probing technique. Further, the probe node 908 may be associated with the active nodes 902-906 such that the probe node 918 may be associated with the active node 902, the probe node 920 may be associated with the active node 904, and the probe node 922 may be associated with the active node 906. The path dataset 926 may have a description similar to the path dataset 722. The path dataset 926 may include information associated with various intermediate active nodes that directly or indirectly associate the active nodes 902-906 with each other and/or other active nodes of the plurality of active nodes.

Based on a stimulus (for example, the stimulus 230) indicative of detection of an intersection node associated with each of the active nodes 902-906, the processing circuitry (for example, the controller module 206, the transaction module 208, the stimuli management module 212, the probe node management module 236, or the like) may be configured to identify the active nodes 902-906. Subsequently, the probe node 908 may be determined based on association with at least one of the active nodes 902-906.

Subsequently, the processing circuitry (for example, the controller module 206, the transaction module 208, the probe node management module 236, or the like) may be configured to execute the path detection operation based on the active node 902-906 and the probe node 908. The path detection operation may be executed based on each of the probe nodes 918-922 implementing the probing technique 924 to determine various paths that associate the active nodes 902-906 with each other. The probe node 918 may determine various paths that associate the active node 902 with the active nodes 904 and 906. The probe node 920 may determine various paths that associate the active node 904 with the active nodes 902 and 906. Similarly, the probe node 922 may determine various paths that associate the active node 906 with the active nodes 902 and 904. Each of the probe nodes 918-922 may use the path dataset 926 for execution of the path detection operation. In an example, paths from the active node 902 to the active nodes 904 and 906 may be determined by, starting from the active node 902, traversing each active node that is directly or indirectly associated with the active node 902 until the active nodes 904 and 906 may get traversed. Similarly, various paths that connect the active nodes 904 and 906 with each other may be determined. Subsequently, active nodes that may have an edge node-type and may be common in paths that connect the active nodes 902, 904, and 906 with each other, may be determined as preliminary intersection nodes. Subsequently, each of the preliminary intersection nodes may be analyzed for the set of parameters and an optimal intersection node may be determined.

For example, the probe node 918 may determine a first path that includes the intermediate active nodes 910-914 and connects the active node 902 to the active node 904, a second path that includes the intermediate active node 916 and connects the active node 902 to the active node 904, and a third path that includes the intermediate active nodes 916 and 912 and connects the active node 902 to the active node 906. The probe node 920 may determine a fourth path that includes the active nodes 914, 912, and 910 and connects the active node 904 with the active node 902, a fifth path that includes the intermediate active node 916 and connects the active node 904 with the active node 902, and a sixth path that includes the intermediate active nodes 914, and 912 and connects the active node 904 with the active node 906. The probe node 922 may determine a seventh path that includes the intermediate active nodes 912 and 910 and connects the active nodes 906 and 902, an eighth path that includes the intermediate active nodes 912 and 916 and connects the active node 906 with the active nodes 902 and 904, and a ninth path that includes the intermediate active nodes 912 and 914 and connects the active nodes 906 and 904. Further, the probe node 908 may compare the first through ninth paths to determine that the intermediate active nodes 912 and 916 may be used as intersection nodes that are indirectly associated with each of the active nodes 902-906.

However, the intermediate active node 916 may be a private access node or a protected access node and in addition may be an inaccessible node. Hence, the intermediate active node 916 may not act as the intersection node. Therefore, the probe node 908 may further determine the intermediate active node 912 as an alternate intersection node. The intermediate active node 912 when determined as the alternate intersection node may be used for one or more operations associated with the overlay system 202.

In some embodiments, the probe node 908 may have permission or ownership to access the intermediate active node 916. In such embodiments, the intermediate active node 916 may be determined as the intersection node.

It will be apparent to a person skilled in the art that an operation performed by a node is actually performed by the processing circuitry while using the node.

Having discussed various scenarios of implementation of the plurality of probe nodes, the description now moves towards an exemplary implementation of the executable graph-based model 100 implementing the probe nodes.

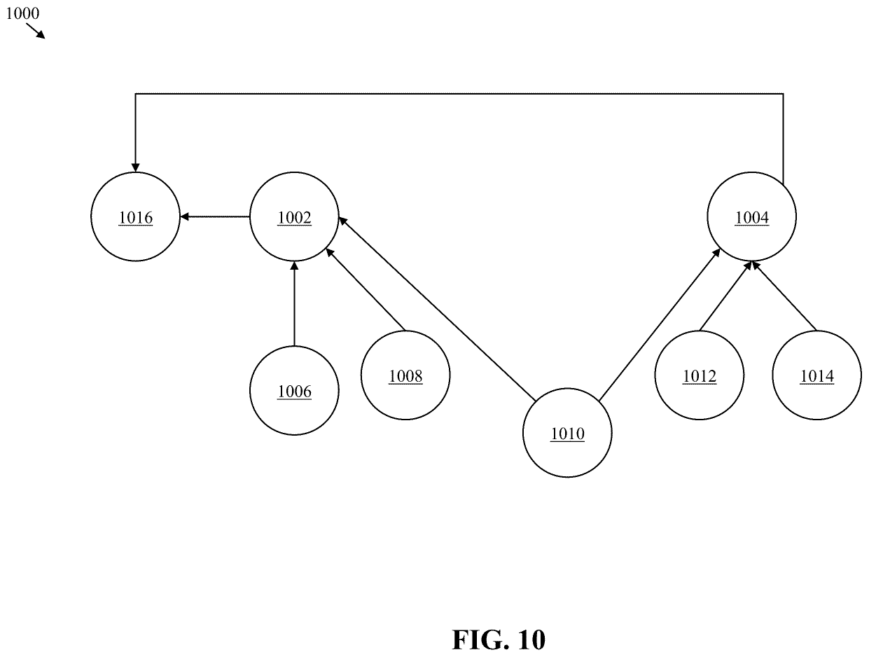

FIG. 10 illustrates a graph 1000 that depicts a recommendation system implemented using the executable graph-based model 100, consistent with disclosed embodiments of the present disclosure. Referring to FIG. 10, shown are active nodes 1002 and 1004 that represent a first user and a second user, respectively, of an ‘online book library and store’ implemented by way of the overlay system 202. Each of the first and second users may read one or more books and may purchase one or more books associated with the ‘online book library and store’. A book purchased by a user may be represented as an active node with an edge node-type in the executable graph-based model 100. Such an active node is referred to herein as an edge node. The edge node representing the book may be associated with an active node representing the user. As shown, the active node 1002 is associated with edge nodes 1006, 1008, and 1010 representing books B1, B2, and B3, respectively that may be purchased/read by the first user represented by the active node 1002. Similarly, the active node 1004 is associated with edge nodes 1010, 1012, and 1014 representing books B3, B4, and B5 which represent books purchased/read by the second user represented by the active node 1004.

The graph 1000 further includes a probe node 1016 associated with the active node 1002 and the active node 1004. The probe node 1016 may have a probing technique (not shown) and a path dataset (not shown). The path dataset may include path information associated with intermediate active nodes that form paths associated with each of the active nodes 1002 and 1004. Based on an execution of a path detection operation as described throughout the description, the probe node 1016 may determine the edge node 1010 as an intersection node associated with each of the active nodes 1002 and 1004. The probe node 1016 may be used by the processing circuitry (for example, the controller module 206, the transaction module 208, the probe node management module 236, or the like) to determine the intersection node (hereinafter, the intersection node 1010) as described throughout the description.

The processing circuitry (for example, the controller module 206, the transaction module 208, the probe node management module 236, or the like) may be further configured to generate a query ‘What are other books associated with the active node 1002?’. A response to the query may be books represented by the edge nodes 1006 and 1008. Therefore, the books represented by the edge nodes 1006 and 1008 may be recommended to the second user represented by the active node 1004. Similarly, the books represented by the edge nodes 1012 and 1014 may be recommended to the first user represented by the active node 1002.

Overlay system 202 that implements the plurality of probe nodes may have various applications that may include, but are not limited to: graph traversal optimization, query optimization, indexing, graph partitioning, dynamic graph monitoring, graph compression, parallelization and distribution, and cost-based optimization.

In some embodiments, a probe node may be used to precompute and store information about a graph structure of the executable graph-based model 100. For example, precomputing and storing shortest paths, distances, or reachability information may significantly reduce time complexity and/or processing complexity associated with various operations of the overlay system 202.

In some embodiments, a probe node may be used to gather statistics, such as degrees of correlations or edge weights, associated with the executable graph-based model 100. These statistics may be utilized to optimize query planning and execution, leading to more efficient retrieval of relevant data.

In some embodiments, a probe node may be used to build indexes or data structures associated with the executable graph-based model 100. The indexes may store information about node properties, relationships, or other relevant features, facilitating quick look-up and retrieval operations.

In some embodiments, a probe node may be used to identify an optimal partitioning of the executable graph-based model 100 into smaller subgraphs. By understanding the connectivity patterns within the executable graph-based model 100, the probe node may facilitate the partitioning to minimize inter-partition communication and improve parallel processing efficiency.

In some embodiments, a probe node may be used to dynamically monitor changes in the executable graph-based model 100. By detecting modifications such as edge insertions, deletions, or node updates, the probe node may enable adaptive techniques that adjust processing strategies in real-time, leading to more efficient processing of evolution of the executable graph-based model 100.

In some embodiments, a probe node may be used to identify patterns or redundancies within the graph structure of the executable graph-based model 100. The identified patterns or redundancies may be leveraged to develop compression techniques, reducing storage requirements and potentially speeding up processing by minimizing an amount of data that needs to be processed.

In some embodiments, a probe node may be used in designing efficient parallel and distributed processing strategies. By understanding graph topology and characteristics of the executable graph-based model 100, the probe node may facilitate allocation of computational resources and distribution of graph data such that an overall processing performance of the overlay system 202 may be optimized.

In some embodiments, a probe node may be used to generate one or more insights associated with cost of various operations associated with the overlay system 202. The insights may be used to design cost-based optimization strategies that prioritize certain operations over others, leading to more efficient execution of the operations.

Having described a practical implementation of the executable graph-based model 100, the description now moves towards a computing system that may facilitate such an implementation.

FIG. 11 shows an example computing system 1100 for carrying out the methods of the present disclosure, consistent with disclosed embodiments of the present disclosure. Specifically, FIG. 11 shows a block diagram of an embodiment of the computing system 1100 according to example embodiments of the present disclosure.

The computing system 1100 may be configured to perform any of the operations disclosed herein, such as for example, any of the operations discussed with reference to the functional modules described in relation to FIG. 2. The computing system 1100 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 1100 is a distributed system configured to function using multiple computing machines interconnected via a data network or bus system.

The computing system 1100 includes computing devices (such as a computing device 1102). The computing device 1102 includes one or more processors (such as a processor 1104) and a memory 1106. The processor 1104 may be any general-purpose processor(s) configured to execute a set of instructions. For example, the processor 1104 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 1104 may be multiple processing units, a single processing core, multiple processing cores, special purpose processing cores, co-processors, or any combination thereof. The processor 1104 may be communicatively coupled to the memory 1106 via an address bus 1108, a control bus 1110, a data bus 1112, and a messaging bus 1111.

The memory 1106 may include non-volatile memories such as a read-only memory (ROM), a programable read-only memory (PROM), an erasable programmable read-only memory (EPROM), a flash memory, or any other device capable of storing program instructions or data with or without applied power. The memory 1106 may also include volatile memories, such as a random-access memory (RAM), a static random-access memory (SRAM), a dynamic random-access memory (DRAM), and a synchronous dynamic random-access memory (SDRAM). The memory 1106 may include single or multiple memory modules. While the memory 1106 is depicted as part of the computing device 1102, a person skilled in the art will recognize that the memory 1106 can be separate from the computing device 1102.

The memory 1106 may store information that can be accessed by the processor 1104. For instance, the memory 1106 (e.g., one or more non-transitory computer-readable storage mediums, memory devices) may include computer-readable instructions (not shown) that can be executed by the processor 1104. The computer-readable instructions may be software written in any suitable programming language or may be implemented in hardware. Additionally, or alternatively, the computer-readable instructions may be executed in logically and/or virtually separate threads on the processor 1104. For example, the memory 1106 may store instructions (not shown) that when executed by the processor 1104 cause the processor 1104 to perform operations such as any of the operations and functions for which the computing system 1100 is configured, as described herein. Additionally, or alternatively, the memory 1106 may store data (not shown) that can be obtained, received, accessed, written, manipulated, created, and/or stored. The data can include, for instance, the data and/or information described herein in relation to FIGS. 1-10. In some implementations, the computing device 1102 may obtain from and/or store data in one or more memory device(s) that are remote from the computing system 1100.

The computing device 1102 may further include an input/output (I/O) interface 1116 communicatively coupled to the address bus 1108, the control bus 1110, and the data bus 1112. The data bus 1112 and messaging bus 1114 may include a plurality of tunnels that may support parallel execution of messages by the overlay system 202. The I/O interface 1116 is configured to couple to one or more external devices (e.g., to receive and send data from/to one or more external devices). Such external devices, along with the various internal devices, may also be known as peripheral devices. The I/O interface 1116 may include both electrical and physical connections for operably coupling the various peripheral devices to the computing device 1102. The I/O interface 1116 may be configured to communicate data, addresses, and control signals between the peripheral devices and the computing device 1102. The I/O interface 1116 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, Fire Wire, various video buses, or the like. The I/O interface 1116 is configured to implement only one interface or bus technology. Alternatively, the I/O interface 1116 is configured to implement multiple interfaces or bus technologies. The I/O interface 1116 may include one or more buffers for buffering transmissions between one or more external devices, internal devices, the computing device 1102, or the processor 1104. The I/O interface 1116 may couple the computing device 1102 to various input devices, including mice, touch screens, scanners, biometric readers, electronic digitizers, sensors, receivers, touchpads, trackballs, cameras, microphones, keyboards, any other pointing devices, or any combinations thereof. The I/O interface 1116 may couple the computing device 1102 to various output devices, including video displays, speakers, printers, projectors, tactile feedback devices, automation control, robotic components, actuators, motors, fans, solenoids, valves, pumps, transmitters, signal emitters, lights, and so forth.

The computing system 1100 may further include a storage unit 1118, a network interface 1120, an input controller 1122, and an output controller 1124. The storage unit 1118, the network interface 1120, the input controller 1122, and the output controller 1124 are communicatively coupled to the central control unit (e.g., the memory 1106, the address bus 1108, the control bus 1110, and the data bus 1112) via the I/O interface 1116. The network interface 1120 communicatively couples the computing system 1100 to one or more networks such as wide area networks (WAN), local area networks (LAN), intranets, the Internet, wireless access networks, wired networks, mobile networks, telephone networks, optical networks, or combinations thereof. The network interface 1120 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 1118 is a computer-readable medium, preferably a non-transitory computer-readable medium, comprising one or more programs, the one or more programs comprising instructions which when executed by the processor 1104 cause the computing system 1100 to perform the method steps of the present disclosure. Alternatively, the storage unit 1118 is a transitory computer-readable medium. The storage unit 1118 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 1118 stores one or more operating systems, application programs, program modules, data, or any other information. The storage unit 1118 is part of the computing device 1102. Alternatively, the storage unit 1118 is part of one or more other computing machines that are in communication with the computing device 1102, such as servers, database servers, cloud storage, network attached storage, and so forth.

The input controller 1122 may include suitable logic, circuitry, interfaces, and/or code, executable by the circuitry, that may be configured to control one or more input devices that may be configured to receive an input (the stimulus 230) for the overlay system 202. The output controller 1124 may include suitable logic, circuitry, interfaces, and/or code, executable by the circuitry, that may be configured to control one or more output devices that may be configured to render/output the outcome of the operation executed to process the received input (for example, the stimulus 230).

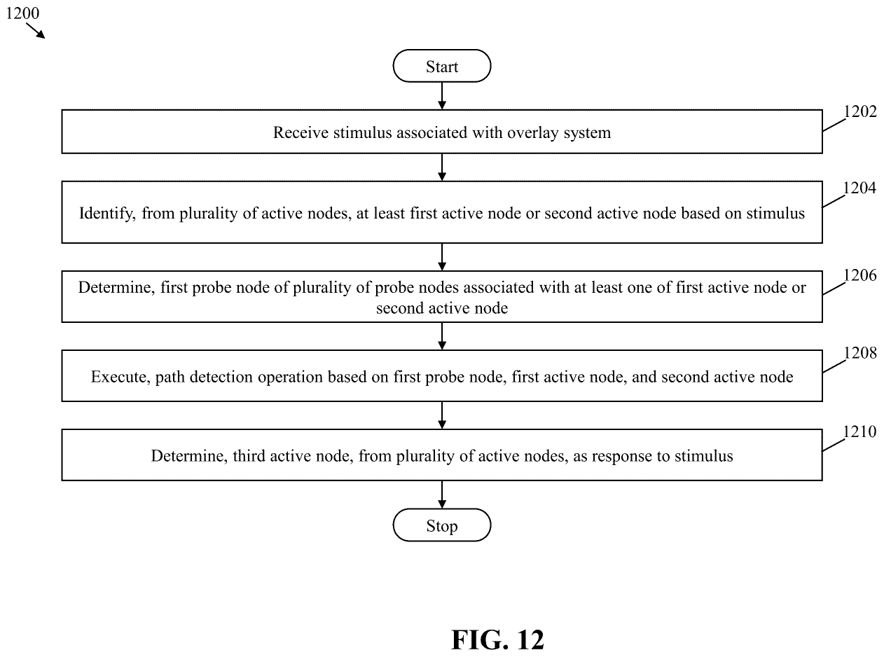

FIG. 12 illustrates a flowchart 1200 of a method for implementation of probe nodes in the executable graph-based model 100, consistent with disclosed embodiments of the present disclosure.

Referring to FIG. 12, at 1202, a stimulus associated with the overlay system 202 may be received. The processing circuitry (for example, the controller module 206, the transaction module 208, the stimuli management module 212, or the like) may receive the stimulus.

At 1204, at least a first active node and a second active node (for example, the generic nodes 702 and 704, the run-time nodes 802 and 804) of the plurality of active nodes, may be identified based on the stimulus. The processing circuitry (for example, the controller module 206, the transaction module 208, the stimuli management module 212, or the like) may identify the first active node and the second active node, of the plurality of active nodes based on the stimulus.

At 1206, a first probe node (for example, the probe node 716, the run-time probe node 816) may be determined from the plurality of probe nodes of the executable graph-based model 100. The processing circuitry (for example, the controller module 206, the transaction module 208, the probe node management module 236, or the like) may determine the first probe node based on the first probe node being associated with at least one of the first and second active nodes.

At 1208, a path detection operation is executed based on the first probe node, the first active node, and the second active node. The processing circuitry (for example, the controller module 206, the transaction module 208, the probe node management module 236, or the like) may execute the path detection operation based on the first probe node, the first active node, and the second active node.

At 1210, based on the path detection operation, a third active node is determined as a response to the stimulus. The third active node may correspond to an intersection node that is associated with each of the first and second active nodes.

It should be appreciated that references to terms such as ‘first component,’ ‘second component,’ or other similar terminology in the claims are not intended to refer to specific instances of the component but are merely used to distinguish between elements. These components may correspond to any of the embodiments described in the specification, including, but not limited to, those explicitly illustrated or discussed, or any other applicable variation described herein. Here, a component may be an active node, a probe node, an overlay node, or any other node of the executable graph-based model 100.

The disclosed embodiments encompass numerous advantages including a simple and user-friendly implementation of the executable graph-based model 100 that may be in turn used to implement various complex and advanced applications. The disclosed overlay system 202 significantly reduces various challenges associated with a subpar ability of existing graph-based models to identify relationships among nodes, that may not be evident. The disclosed overlay system 202 implements the plurality of probe nodes that includes processing logic that when executed may efficiently identify various indirect relationships of an associated active node with other active nodes of the executable graph-based model 100. The probe node may cater to the dynamic and ever-expanding nature of the executable graph-based model 100. The probe nodes may perform such path detection regardless of a size and complexity of the executable graph-based model 100. By leveraging customized and optimized path detection algorithms, the disclosed overlay system 202 significantly reduces computational demands while ensuring real-time processing capabilities. This enhances accuracy in detecting hidden connections, leading to improved insights for applications such as recommendation systems, fraud detection, network analysis, or the like. Additionally, the disclosed overlay system 202 is highly scalable, making it suitable for handling vast and dynamic datasets across various industries, including, but not limited to, marketing, hospitality, research, healthcare, and finance.

The disclosed overlay system 202 simplifies operations for end-users by automating and simplifying the detection of indirect relationships, reducing complexity and the need for extensive technical expertise. The overlay system 202 exhibits an ability to enhance data utilization that may allow its users to extract maximum value from data stored by way of the executable graph-based model 100, leading to better decision-making and operational efficiency.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems, and methods for facilitating implementation of probe nodes in executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:
1. An overlay system, comprising:
   a storage element configured to store an executable graph-based model that includes a plurality of active nodes and a plurality of probe nodes; and processing circuitry that is coupled to the storage element, and configured to:
   receive a stimulus associated with the overlay system;
   identify, from the plurality of active nodes, at least a first active node and a second active node based on the stimulus;
      determine a first probe node of the plurality of probe nodes associated with at least one of the first active node or the second active node;
   execute a path detection operation based on the first probe node, the first active node, and the second active node; and
   determine, as a response to the stimulus, a third active node, from the plurality of active nodes, as an intersection node based on the path detection operation, with the intersection node being associated with each of the first active node and the second active node.
2. The overlay system of 1,
   wherein the first active node and the second active node are associated with each other by way of an indirect connection, and
   wherein the first active node is associated with the second active node via at least the third active node.
3. The overlay system of 1, wherein each of the first active node and the second active node is one of: a vertex node, an edge node, an overlay node, or a role node.
4. The overlay system of 1,
   wherein a node-type of the first probe node corresponds to a combination of an edge node-type and an overlay node-type,
   wherein the association of the first probe node with at least one of the first active node or the second active node is based on the edge node-type, and
   wherein the execution of the path detection operation by way of the first probe node is based on the overlay node-type.
5. The overlay system of 1,
   wherein the first probe node has a first probing technique and a second probing technique associated therewith,
   wherein the path detection operation is executed further based on implementation of the first probing technique and the second probing technique,
   wherein based on the execution of the path detection operation by way of the implementation of the first probing technique, the intersection node corresponds to the third active node,
   wherein based on the execution of the path detection operation by way of the implementation of the second probing technique, the intersection node corresponds to a fourth active node of the plurality of active nodes, and
   wherein the processing circuitry is further configured to:
      compare, based on the first probe node, the third active node and the fourth active node for a set of parameters; and
      determine, based on the comparison, the third active node as an optimal intersection node as the response to the stimulus.
6. The overlay system of 5, wherein the set of parameters includes at least one of: (i) a cost of traversal between the first active node and the second active node, (ii) time required for a traversal between the first active node and the second active node, or (iii) processing requirement for the traversal between the first active node and the second active node.
7. The overlay system of 1, wherein the third active node corresponds to an edge node of the executable graph-based model that couples the first active node and the second active node.
8. The overlay system of 1,
   wherein the path detection operation corresponds to a unidirectional path detection operation, and
   wherein the third active node is determined further based on detection of a path from the first active node to the second active node.
9. The overlay system of 1,
   wherein the path detection operation corresponds to a bi-directional path detection operation,
   wherein the third active node is determined further based on detection of at least one of: (i) a first path from the first active node to the second active node or (ii) a second path from the second active node to the first active node, and
   wherein the third active node is associated with each of the first path and the second path.
10. The overlay system of 1, wherein the third active node corresponds to one of an accessible node or an inaccessible node.
11. The overlay system of 10,
   wherein based on the third active node being the inaccessible node, the processing circuitry is further configured to determine, based on the path detection operation, a fourth active node of the plurality of active nodes as the response to the stimulus, and
   wherein the fourth active node corresponds to an alternative intersection node that is associated with each of the first active node and the second active node.
12. The overlay system of 1,
   wherein the first probe node corresponds to a first composite node of the executable graph-based model with a composite node being a combination of two or more probe nodes of the plurality of probe nodes, wherein the first probe node includes a second probe node and a third probe node, and wherein the path detection operation is executed further based on the second probe node and the third probe node.
13. The overlay system of 12,
   wherein the first probe node is associated with a first probing technique,
   wherein based on the first probe node being associated with the first probing technique, the processing circuitry is further configured to associate the first probing technique with each of the second probe node and the third probe node, and
   wherein the path detection operation is executed further based on each of the second probe node and the third probe node implementing the first probing technique.
14. The overlay system of 12,
   wherein the first probe node is associated with a first probing technique,
   wherein the second probe node is associated with a second probing technique,
   wherein the processing circuitry is further configured to associate the third probe node with the first probing technique, and
   wherein the path detection operation is executed further based on the second probe node implementing the second probing technique and the third probe node implementing the first probing technique.
15. The overlay system of 12,
   wherein the second probe node is associated with a first probing technique and the third probe node is associated with a second probing technique, and
   wherein the path detection operation is executed further based on the second probe node implementing the first probing technique and the third probe node implementing the second probing technique.
16. The overlay system of 12, wherein at least one of the second probe node or the third probe node corresponds to the composite node.
17. The overlay system of 1,
   wherein the first probe node is included in each of a first composite node and a second composite node, of the executable graph-based model,
   wherein a composite node corresponds to a combination of two or more probe nodes of the plurality of probe nodes,
   wherein the first composite node is associated with at least one of the first active node or the second active node, and
   wherein based on the first composite node being associated with at least one of the first active node or the second active node, the path detection operation is executed further based on the first probe node implementing a first probing technique of the first composite node.
18. The overlay system of 1,
   wherein the first probe node further includes a path dataset associated with the at least one of the first active node or the second active node,
   wherein the path dataset is indicative of one or more active nodes of the plurality of active nodes that form one or more connection links between the first active node and the second active node, and
   wherein the path detection operation is executed further based on the path dataset of the first probe node.
19. The overlay System of 1,
   wherein the executable graph-based model further includes a plurality of overlay nodes,
   wherein the first probe node is associated with a first overlay node of the plurality of overlay nodes, and
   wherein the path detection operation is executed further based on the first overlay node.
20. The overlay system of 1, wherein the first probe node corresponds to one of: a public access node, a private access node, or a protected access node.
21. The overlay system of 1, wherein the first probe node corresponds to at least one of a manual probe node or an automated probe node.
22. The overlay system of 21, wherein based on the stimulus being an external stimulus, the first probe node corresponds to the manual probe node.
23. The overlay system of 21, wherein based on the stimulus being an internal stimulus, the first probe node corresponds to the automated probe node.
24. The overlay system of 1,
   wherein for the execution of the path detection operation, the processing circuitry is further configured to use the first probe node to associate a first anchor point with the first active node and a second anchor point with the second active node, and
   wherein the path detection operation is executed further based on the first anchor point and the second anchor point.
25. The overlay system of 1,
   wherein the first probe node corresponds to a stateful node, and
   wherein based on the first probe node being the stateful node the determination of the third active node as the intersection node persists in the executable graph-based model upon an unloading of the first probe node.
26. The overlay system of 1,
   wherein the first probe node corresponds to a stateless node, and
   wherein based on the first probe node being the stateless node the determination of the third active node as the intersection node ceases to exist in the executable graph-based model upon an unloading of the first probe node.
27. The overlay system of 1, wherein the processing circuitry is further configured to determine, based on the stimulus, whether at least one of: the first active node, the second active node, or the first probe node is unloaded from the executable graph-based model.
28. The overlay system of 27, wherein based on at least one of the first active node, the second active node, or the first probe node being unloaded, from the executable graph-based model, the processing circuitry is further configured to load at least one of the first active node, the second active node, or the first probe node, in the executable graph-based model.
29. The overlay system of 1, wherein each of the first active node and the second active node corresponds to a generic node, and the first probe node corresponds to a generic probe node.
30. The overlay system of 1,
   wherein each of the first active node and the second active node corresponds to a run-time node that includes (i) a node template that defines a node structure and (ii) a node instance that is an implementation of the node template, and
   wherein based on each of the first active node and the second active node being the run-time node, the first probe node corresponds to a run-time probe node that includes (i) a probe node template that defines a probe node structure and (ii) a probe node instance that is an implementation of the probe node template.
31. The overlay system of 30,
   wherein the run-time node is loaded based on loading of the node template and the node instance, and
   wherein the run-time probe node is loaded based on loading of the probe node template and the probe node instance.
32. A method, comprising:
   receiving, by processing circuitry of an overlay system, a stimulus associated with the overlay system,
      wherein an executable graph-based model is stored in a storage element of the overlay system and includes a plurality of active nodes and a plurality of probe nodes;
   identifying, by the processing circuitry, from the plurality of active nodes, at least a first active node and a second active node based on the stimulus;
   determining, by the processing circuitry, a first probe node of the plurality of probe nodes associated with at least one of the first active node or the second active node;
   executing, by the processing circuitry, a path detection operation based on the first probe node, the first active node, and the second active node; and
   determining, by the processing circuitry based on the path detection operation, a third active node, from the plurality of active nodes, as a response to the stimulus, wherein the third active node corresponds to an intersection node associated with each of the first active node and the second active node.

1. An overlay system, comprising:
a storage element configured to store an executable graph-based model that includes a plurality of active nodes and a plurality of probe nodes; and
processing circuitry that is coupled to the storage element, and configured to:
receive a stimulus associated with the overlay system;
identify, from the plurality of active nodes, at least a first active node and a second active node based on the stimulus;
determine a first probe node of the plurality of probe nodes associated with at least one of the first active node or the second active node;
execute a path detection operation based on the first probe node, the first active node, and the second active node; and
determine, as a response to the stimulus, a third active node, from the plurality of active nodes, as an intersection node based on the path detection operation, with the intersection node being associated with each of the first active node and the second active node.

2. The overlay system of claim 1,
wherein the first active node and the second active node are associated with each other by way of an indirect connection, and
wherein the first active node is associated with the second active node via at least the third active node.

3. The overlay system of claim 1,
wherein the first probe node has a first probing technique and a second probing technique associated therewith,
wherein the path detection operation is executed further based on implementation of the first probing technique and the second probing technique,
wherein based on the execution of the path detection operation by way of the implementation of the first probing technique, the intersection node corresponds to the third active node,
wherein based on the execution of the path detection operation by way of the implementation of the second probing technique, the intersection node corresponds to a fourth active node of the plurality of active nodes, and
wherein the processing circuitry is further configured to:
compare, based on the first probe node, the third active node and the fourth active node for a set of parameters; and
determine, based on the comparison, the third active node as an optimal intersection node as the response to the stimulus.

4. The overlay system of claim 3, wherein the set of parameters includes at least one of: (i) a cost of traversal between the first active node and the second active node, (ii) time required for a traversal between the first active node and the second active node, or (iii) processing requirement for the traversal between the first active node and the second active node.

5. The overlay system of claim 1,
wherein the path detection operation corresponds to a unidirectional path detection operation, and
wherein the third active node is determined further based on detection of a path from the first active node to the second active node.

6. The overlay system of claim 1,
wherein the path detection operation corresponds to a bi-directional path detection operation,
wherein the third active node is determined further based on detection of at least one of: (i) a first path from the first active node to the second active node or (ii) a second path from the second active node to the first active node, and
wherein the third active node is associated with each of the first path and the second path.

7. The overlay system of claim 1,
wherein the third active node corresponds to one of an accessible node or an inaccessible node,
wherein based on the third active node being the inaccessible node, the processing circuitry is further configured to determine, based on the path detection operation, a fourth active node of the plurality of active nodes as the response to the stimulus, and
wherein the fourth active node corresponds to an alternative intersection node that is associated with each of the first active node and the second active node.

8. The overlay system of claim 1,
wherein the first probe node corresponds to a first composite node of the executable graph-based model with a composite node being a combination of two or more probe nodes of the plurality of probe nodes,
wherein the first probe node includes a second probe node and a third probe node, and
wherein the path detection operation is executed further based on the second probe node and the third probe node.

9. The overlay system of claim 8,
wherein the first probe node is associated with a first probing technique,
wherein based on the first probe node being associated with the first probing technique, the processing circuitry is further configured to associate the first probing technique with each of the second probe node and the third probe node, and
wherein the path detection operation is executed further based on each of the second probe node and the third probe node implementing the first probing technique.

10. The overlay system of claim 8,
wherein the first probe node is associated with a first probing technique, wherein the second probe node is associated with a second probing technique,
wherein the processing circuitry is further configured to associate the third probe node with the first probing technique, and
wherein the path detection operation is executed further based on the second probe node implementing the second probing technique and the third probe node implementing the first probing technique.

11. The overlay system of claim 8,
wherein the second probe node is associated with a first probing technique and the third probe node is associated with a second probing technique, and
wherein the path detection operation is executed further based on the second probe node implementing the first probing technique and the third probe node implementing the second probing technique.

12. The overlay system of claim 1,
wherein the first probe node further includes a path dataset associated with the at least one of the first active node or the second active node,
wherein the path dataset is indicative of one or more active nodes of the plurality of active nodes that form one or more connection links between the first active node and the second active node, and
wherein the path detection operation is executed further based on the path dataset of the first probe node.

13. The overlay system of claim 1,
wherein the executable graph-based model further includes a plurality of overlay nodes,
wherein the first probe node is associated with a first overlay node of the plurality of overlay nodes, and
wherein the path detection operation is executed further based on the first overlay node.

14. The overlay system of claim 1, wherein the first probe node corresponds to one of: a public access node, a private access node, or a protected access node.

15. The overlay system of claim 1,
wherein the first probe node corresponds to at least one of a manual probe node or an automated probe node,
wherein based on the stimulus being an external stimulus, the first probe node corresponds to the manual probe node, and
wherein based on the stimulus being an internal stimulus, the first probe node corresponds to the automated probe node.

16. The overlay system of claim 1,
wherein for the execution of the path detection operation, the processing circuitry is further configured to use the first probe node to associate a first anchor point with the first active node and a second anchor point with the second active node, and
wherein the path detection operation is executed further based on the first anchor point and the second anchor point.

17. The overlay system of claim 1,
wherein the first probe node corresponds to a stateful node, and
wherein based on the first probe node being the stateful node, the determination of the third active node as the intersection node persists in the executable graph-based model upon an unloading of the first probe node.

18. The overlay system of claim 1,
wherein the first probe node corresponds to a stateless node, and
wherein based on the first probe node being the stateless node, the determination of the third active node as the intersection node ceases to exist in the executable graph-based model upon an unloading of the first probe node.

19. The overlay system of claim 1,
wherein each of the first active node and the second active node corresponds to a run-time node that includes (i) a node template that defines a node structure and (ii) a node instance that is an implementation of the node template, and p1 wherein based on each of the first active node and the second active node being the run-time node, the first probe node corresponds to a run-time probe node that includes (i) a probe node template that defines a probe node structure and (ii) a probe node instance that is an implementation of the probe node template.

20. A method, comprising:
receiving, by processing circuitry of an overlay system, a stimulus associated with the overlay system,
wherein an executable graph-based model is stored in a storage element of the overlay system and includes a plurality of active nodes and a plurality of probe nodes;
identifying, by the processing circuitry, from the plurality of active nodes, at least a first active node and a second active node based on the stimulus;
determining, by the processing circuitry, a first probe node of the plurality of probe nodes associated with at least one of the first active node or the second active node;
executing, by the processing circuitry, a path detection operation based on the first probe node, the first active node, and the second active node; and
determining, by the processing circuitry based on the path detection operation, a third active node, from the plurality of active nodes, as a response to the stimulus, wherein the third active node corresponds to an intersection node associated with each of the first active node and the second active node.
